(19) United States
(12) Patent Application Publication
(10) Pub. No.: US 2026/0154028 A1
(43) Pub. Date: Jun. 4, 2026

(54) METHOD OF PROCESSING INFORMATION IN INFORMATION PROCESSING APPARATUS AND DISPLAY SYSTEM

(71) Applicant: SEIKO EPSON CORPORATION, Tokyo (JP)

(72) Inventor: Ikuto KANBARA, MATSUMOTO-SHI (JP)

(21) Appl. No.: 19/406,436

(22) Filed: Dec. 2, 2025

(30) Foreign Application Priority Data
Dec. 3, 2024 (JP) 2024-209977

(51) Int. Cl. G06F 3/14; G06F 16/957

(52) U.S. Cl. CPC G06F 3/1454; G06F 16/9577

(57) ABSTRACT

A method of processing information in an information processing apparatus includes receiving a display operation of displaying a setting page for setting the projection apparatus on a web browser, executing display processing of displaying a setting window including the setting page in a first size on a display screen based on the display operation, receiving a projection instruction operation of instructing the projection apparatus to project the display screen in the setting page, and executing, based on the projection instruction operation, window display processing of displaying, in a second size smaller than the first size, an acquisition window for acquiring display data for instructing the projection apparatus to project the display screen, and data transmission processing of transmitting the display data to the projection apparatus via the acquisition window.

The present application is based on, and claims priority from JP Application Serial Number 2024-209977, filed December 3, 2024, the disclosure of which is hereby incorporated by reference herein in its entirety.

### BACKGROUND

### 1. Technical Field

The present disclosure relates to a method of processing information in an information processing apparatus and a display system.

### 2. Related Art

An image display apparatus to be coupled to a control apparatus such as a computer is known. A projector described in JP-A-2020-64131 is an example of an image display apparatus. The projector displays an input image based on image information supplied via a coupling terminal. The projector can perform display using Miracast. Miracast is a registered trademark. Miracast is a display transmission technique using wireless communication. The projector can mirror a display screen of the control apparatus using Miracast. Miracast is an example of a technique for performing mirroring.

JP-A-2020-64131 is an example of the related art.

However, processing of the display screen of the control apparatus performed when the projector mirrors the display screen of the control apparatus is not considered.

### SUMMARY

A method of processing information in an information processing apparatus according to the present disclosure includes establishing communicative connection to a projection apparatus, receiving a display operation of displaying a setting page for setting the projection apparatus on a web browser, executing display processing of displaying a setting window including the setting page in a first size on a display screen based on the display operation, receiving a projection instruction operation of instructing the projection apparatus to project the display screen in the setting page, and executing, based on the projection instruction operation, window display processing of displaying, in a second size smaller than the first size, an acquisition window for acquiring display data for displaying the display screen, and data transmission processing of transmitting the display data to the projection apparatus via the acquisition window.

A display system according to the present disclosure includes a projection apparatus, and an information processing apparatus in which a web browser operates, wherein the information processing apparatus is configured to execute establishing communicative connection to the projection apparatus, receiving a display operation of displaying a setting page for setting the projection apparatus on the web browser, performing display processing of displaying a setting window including the setting page in a first size on a display screen based on the display operation, receiving a projection instruction operation of instructing the projection apparatus to project the display screen in the setting page, performing, based on the projection instruction operation, window display processing of displaying, in a second size smaller than the first size, an acquisition window for acquiring display data for displaying the display screen, and data transmission processing of transmitting the display data to the projection apparatus via the acquisition window, and transmitting the display data to the projection apparatus, and the projection apparatus is configured to execute receiving the display data from the information processing apparatus, and projecting the display screen based on the display data.

### BRIEF DESCRIPTION OF THE DRAWINGS

FIG. 1 is a diagram illustrating a schematic configuration of a projection system.

FIG. 2 is a diagram illustrating a block configuration of the projection system.

FIG. 3 is a diagram illustrating a schematic configuration of a projection unit.

FIG. 4 is a diagram illustrating a system configuration of the projection system.

FIG. 5 is a diagram illustrating an example of a display screen.

FIG. 6 is a diagram illustrating a control flow executed by a control apparatus.

FIG. 7 is a diagram illustrating an example of the display screen.

FIG. 8 is a diagram illustrating an example of the display screen.

FIG. 9 is a diagram illustrating an example of the display screen.

FIG. 10 is a diagram illustrating a projection image projected on a projection surface.

FIG. 11 is a diagram illustrating a control flow executed by the control apparatus.

FIG. 12 is a diagram illustrating an example of the display screen.

FIG. 13 is a diagram illustrating an example of the display screen.

FIG. 14 is a diagram illustrating an example of the display screen.

FIG. 15 is a diagram illustrating an example of the display screen.

FIG. 16 is a diagram illustrating a projection image projected on the projection surface.

### DESCRIPTION OF EMBODIMENTS

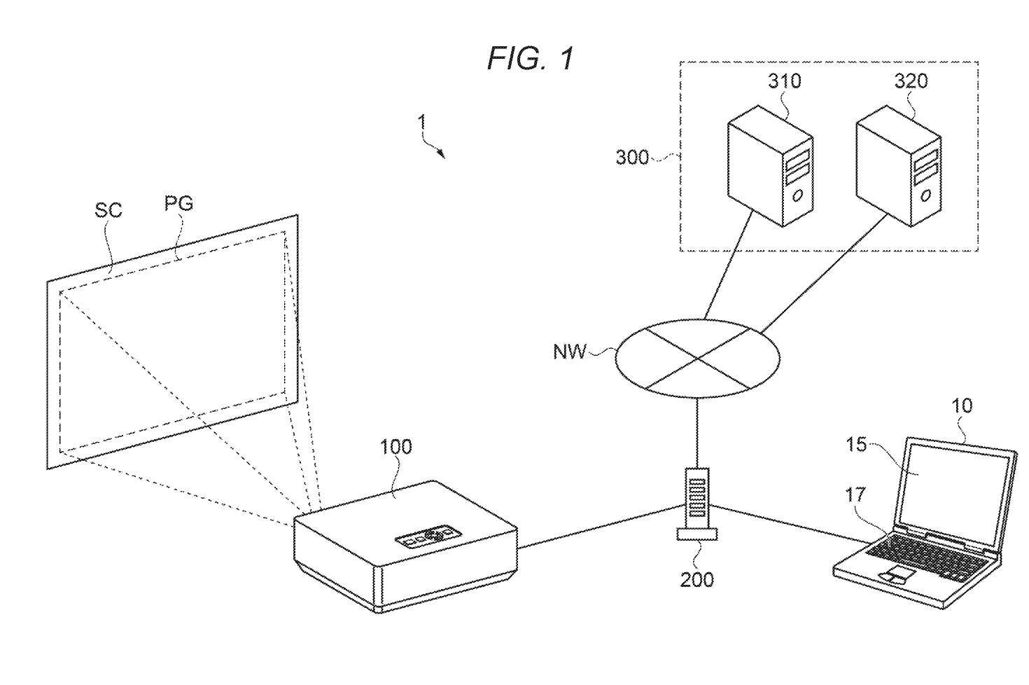

FIG. 1 illustrates a schematic configuration of a projection system 1. The projection system 1 includes a control apparatus 10, a projector 100, a router 200, and a cloud server 300. The projector 100 projects a projection image PG onto a projection surface SC. The cloud server 300 is communicatively connected to the control apparatus 10 via a communication network NW. The projection system 1 illustrated in FIG. 1 includes one control apparatus 10 and one projector 100, but this is not a limitation. The projection system 1 may include a plurality of control apparatuses 10 and a plurality of projectors 100. The projection system 1 corresponds to an example of a display system.

The control apparatus 10 is communicatively connected to the projector 100. The control apparatus 10 transmits projection image data to the projector 100. The control apparatus 10 executes mirroring of causing the projector 100 to project, as the projection image PG, a display screen DS displayed on a display 15. The control apparatus 10 may have a function of adjusting an image shape and so on of the projection image PG to be projected onto the projection surface SC by the projector 100. The control apparatus 10 corresponds to an example of an information processing apparatus. The control apparatus 10 is a tablet terminal, a mobile computer, a desktop personal computer, or the like. FIG. 1 illustrates, as a control apparatus 10, a mobile personal computer including the display 15 and an input unit 17.

The control apparatus 10 executes various programs such as a web browser 80 on a dedicated operating system 70. The dedicated operating system 70 is, as an example, Chrome OS. Chrome is a registered trademark. The dedicated operating system 70 corresponds to an example of an operating system. The dedicated operating system 70 can construct a virtual environment. In the virtual environment, a program that operates on an operating system different from the dedicated operating system 70 is operable. The operating system different from the dedicated operating system 70 is, as an example, Android OS. Android is a registered trademark. The program that operates on the operating system different from the dedicated operating system 70 is, as an example, an Android app.

The display 15 displays a screen including various videos and various images. The display 15 is configured with a liquid crystal panel, an organic electro-luminescence (EL) panel, or the like. The display 15 may have a touch input function of receiving an input operation by a user.

The input unit 17 receives an input operation by the user. FIG. 1 shows a keyboard as the input unit 17, but this is not a limitation. The input unit 17 is configured with a mouse, a touch pad, or the like. When the display 15 has the touch input function, the display 15 functions as the input unit 17.

The projector 100 is disposed at a position facing the projection surface SC. The projector 100 corresponds to an example of a projection apparatus. The projector 100 is communicatively connected to the control apparatus 10. The projector 100 shown in FIG. 1 is communicatively connected to the control apparatus 10 via the router 200, but the projector 100 may be communicatively connected directly to the control apparatus 10. The projector 100 may be communicatively connected to an external apparatus different from the control apparatus 10. The projector 100 receives the projection image data from the control apparatus 10. The projector 100 projects the projection image PG onto the projection surface SC based on the projection image data. The projector 100 may execute mirroring of projecting the display screen DS displayed on the display 15 of the control apparatus 10 based on the projection image data. The projector 100 may project the projection image PG onto the projection surface SC based on OSD data stored in advance. OSD is an abbreviation for on-screen display.

The projection surface SC displays the projection image PG projected from the projector 100. The projection surface SC illustrated in FIG. 1 is formed of a screen, but this is not a limitation. The projection surface SC may be an indoor wall, a ceiling, an outer wall of a building, or the like. A surface shape of the projection surface SC is not limited to a flat surface and may be a three-dimensional shape such as a curved surface, an uneven surface, or a spherical surface.

The router 200 is communication equipment that interconnects the control apparatus 10, the projector 100, and the cloud server 300. The router 200 communicatively connects the control apparatus 10 and the cloud server 300 to each other via the communication network NW. The router 200 communicatively connects the control apparatus 10 and the projector 100 to each other using a predetermined communication protocol. The router 200 may communicatively connect the projector 100 and the cloud server 300 to each other.

The communication network NW communicatively connects the cloud server 300 to the control apparatus 10 and so on. The communication network NW is, as an example, a wide area network (WAN).

The cloud server 300 is a virtual server that operates in a cloud computing environment. The cloud server 300 is a service that uses a single virtualized server or a plurality of virtualized servers via the Internet. The cloud server 300 illustrated in FIG. 1 includes a web server 310 and a WebSocket server 320.

The web server 310 provides display of HTML and objects to the web browser 80 of client software. FIG. 1 virtually illustrates the web server 310. The web server 310 provides web apps to the web browser 80 of the control apparatus 10 based on an instruction from the control apparatus 10. When the control apparatus 10 or the like stores web apps in advance, the projection system 1 is not required to include the web server 310.

The WebSocket server 320 is a server that performs data communication with the web app on the web browser 80 in accordance with the standard of WebSocket. FIG. 1 virtually illustrates the WebSocket server 320. The WebSocket server 320 is used as an SDP exchanging signaling server when the control apparatus 10 performs streaming distribution of shared data or the like using Web Real-Time Communication (WebRTC) technology. SDP is an abbreviation for Session Description Protocol.

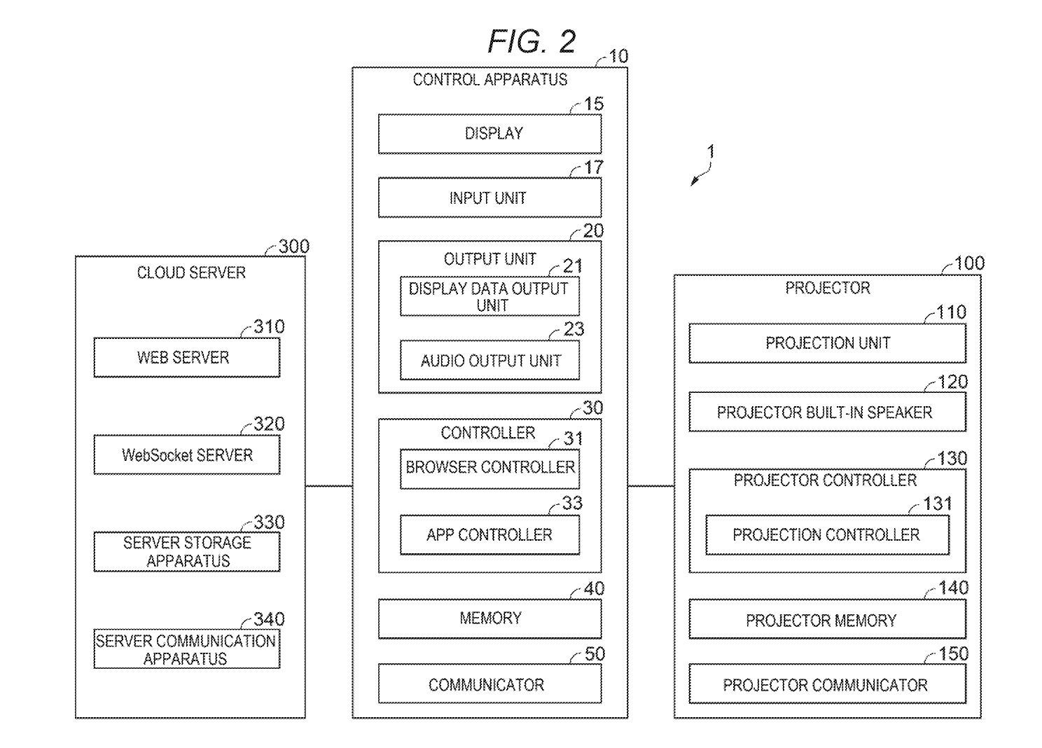

FIG. 2 illustrates a block configuration of the projection system 1. FIG. 2 illustrates a block configuration of the control apparatus 10, the projector 100, and the cloud server 300 provided to the projection system 1. FIG. 2 illustrates the projection system 1 in which the router 200 is omitted.

The control apparatus 10 includes the display 15, the input unit 17, an output unit 20, a controller 30, a memory 40, and a communicator 50. The control apparatus 10 includes a built-in speaker (not shown).

The display 15 displays the display screen DS based on control of the controller 30. The display 15 is coupled to a display data output unit 21 of the output unit 20. The display data output unit 21 will be described later. The display 15 illustrated in FIG. 2 is provided to the control apparatus 10, but this is not a limitation. The display 15 may be a display panel or the like externally attached to the control apparatus 10.

The input unit 17 receives various input operations by the user. The input unit 17 generates an input signal corresponding to an input operation and outputs the input signal to the controller 30. The input unit 17 illustrated in FIG. 2 is provided to the control apparatus 10, but this is not a limitation. The input unit 17 may be an input device externally attached to the control apparatus 10.

The output unit 20 outputs, to the display 15 and so on, various types of generated data generated by the controller 30 and so on. The output unit 20 is configured with various circuits, output ports, and so on. The output unit 20 corresponds to an example of an output unit. The output unit 20 includes a display data output unit 21 and an audio output unit 23.

The display data output unit 21 outputs, to the display 15, video data for displaying a video. The video data includes image data for displaying a still image. The video data belongs to the generated data. The display data output unit 21 may output the video data to a display panel externally attached to the control apparatus 10.

The audio output unit 23 outputs audio data related to an audio. The audio data belongs to the generated data. The audio output unit 23 is coupled to a built-in speaker, an external speaker, or the like (all not shown). The audio output unit 23 outputs the audio data in a wired or wireless manner.

The controller 30 is an apparatus controller that controls each part of the control apparatus 10. The controller 30 is, as an example, a processor including a central processing unit (CPU). The controller 30 is configured with a single processor or a plurality of processors. The dedicated operating system 70 operates in the controller 30. The controller 30 executes various programs on the dedicated operating system 70. The controller 30 functions as various functional units by executing the various programs. As an example, the controller 30 functions as a browser controller 31 and an app controller 33. The controller 30 may function as functional units other than the browser controller 31 and the app controller 33.

The browser controller 31 causes the web browser 80 to operate on the dedicated operating system 70 to display various web pages. The browser controller 31 causes the web app to operate on the web browser 80 to execute a function of the web app. As an example, the browser controller 31 causes a capture app 84 as the web app to operate on the web browser 80 to capture the generated data to be output to the output unit 20. The capture app 84 will be described later in detail.

The app controller 33 causes apps to operate on the dedicated operating system 70 or on the virtual environment. The app controller 33 causes apps having a specification compatible with the dedicated operating system 70 to operate on the dedicated operating system 70. The app controller 33 causes apps having a specification different from the specification compatible with the dedicated operating system 70 to operate on the virtual environment. The virtual environment is constructed on a virtual device 90 that operates on the dedicated operating system 70. The virtual device 90 will be described later.

The memory 40 stores various programs, various data, and so on. The memory 40 stores an apparatus control program, various web apps, various apps, and so on. The memory 40 stores various data and so on generated by the controller 30. The memory 40 is configured with a volatile semiconductor memory such as a random access memory (RAM) and a nonvolatile memory such as a read only memory (ROM) or a flash memory. The memory 40 may function as a work area for the controller 30. The memory 40 corresponds to an example of a memory.

The communicator 50 is a communication interface circuit that communicates with the projector 100, the cloud server 300, and so on. The communicator 50 is communicatively connected wirelessly to the projector 100 and so on in accordance with a predetermined communication protocol. The communicator 50 includes a wireless communication port. The wireless communication port is a wireless local area network (LAN) communication port or the like. The communicator 50 may be communicatively connected to the projector 100 and so on in a wired manner. The communicator 50 includes a wired connector such as a universal serial bus (USB). The communicator 50 transmits various control signals, the projection image data, and so on to the projector 100. The projection image data includes the video data, the audio data, and so on. The communicator 50 receives various data, various signals, and so on from the cloud server 300 and so on.

The projector 100 includes a projection unit 110, a projector built-in speaker 120, a projector controller 130, a projector memory 140, and a projector communicator 150.

The projection unit 110 projects image light based on the projection image data onto the projection surface SC in an enlarged manner. The projection unit 110 projects the projection image PG onto the projection surface SC based on control of the projector controller 130. The projection unit 110 projects a moving image, a still image, an OSD image, and so on as the projection image PG based on the video data and so on contained in the projection image data. The OSD image is an image representing various types of setting, operation information, and so on relating to the projector 100.

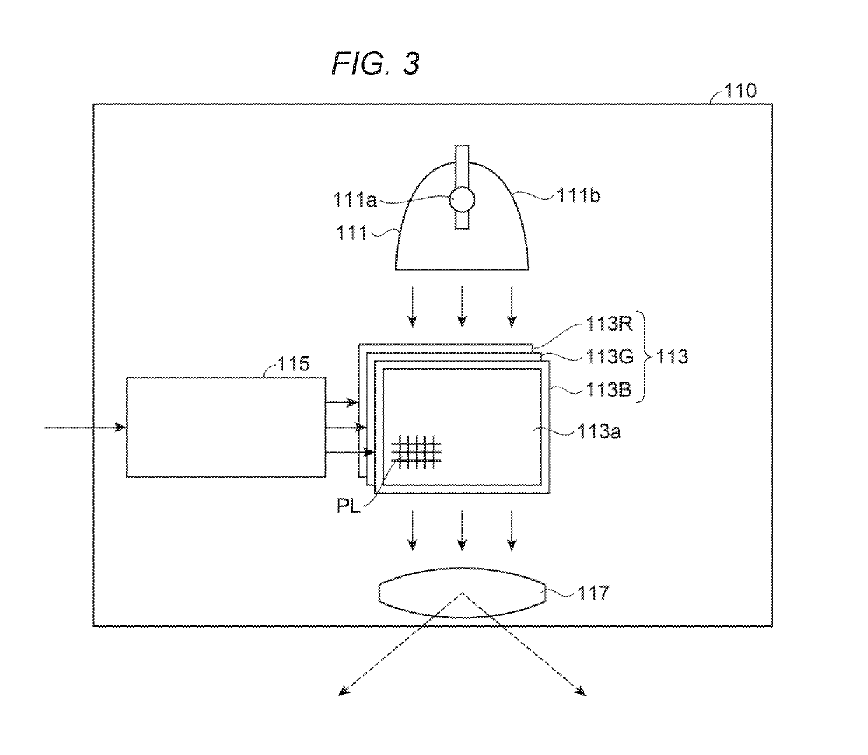

FIG. 3 illustrates a schematic configuration of the projection unit 110. FIG. 3 illustrates an example of the projection unit 110. The projection unit 110 includes a light source 111, three liquid crystal light valves 113, a light valve driver 115, and a projection lens 117.

The light source 111 emits light to the liquid crystal light valves 113. The light source 111 includes a light source unit 111a, a reflector 111b, an integrator optical system (not illustrated), and a color separation optical system (not illustrated). The light source unit 111a emits the light. The light source unit 111a is configured with a xenon lamp, an ultra-high-pressure mercury lamp, a light emitting diode (LED), or a laser light source. The light source unit 111a emits the light based on control by the projector controller 130. The reflector 111b reduces variations in an emission direction of the light emitted by the light source unit 111a. The integrator optical system reduces variations in a luminance distribution of the light emitted by the light source unit 111a. The light having passed through the reflector 111b is incident on the color separation optical system. The color separation optical system separates the incident light into red, green, and blue colored light components.

The liquid crystal light valves 113 modulate the light emitted from the light source 111. The liquid crystal light valves 113 modulate the light to thereby generate the projection image PG and so on. The liquid crystal light valves 113 are each configured with a transmissive liquid crystal panel in which liquid crystal is sealed between a pair of transparent substrates. The liquid crystal light valves 113 each have a rectangular pixel region 113a including a plurality of pixels PL arranged in a matrix. In each of the liquid crystal light valves 113, a drive voltage is applied to the liquid crystal for each of the pixels PL. The projection unit 110 illustrated in FIG. 3 includes the three liquid crystal light valves 113. The projector 100 has a configuration in which the liquid crystal light valves 113 are provided and the transmissive liquid crystal panels are used, but this is not a limitation. The projector 100 may include reflective liquid crystal panels or liquid-crystal-on-silicon (LCOS) liquid crystal panels. The projector 100 may have a configuration in which one or more digital mirror devices (DMDs) are provided.

The three liquid crystal light valves 113 are a red-light liquid crystal light valve 113R, a green-light liquid crystal light valve 113G, and a blue-light liquid crystal light valve 113B. A red colored light component separated by the color separation optical system is incident on the red-light liquid crystal light valve 113R. A green colored light component separated by the color separation optical system is incident on the green-light liquid crystal light valve 113G. A blue colored light component separated by the color separation optical system is incident on the blue-light liquid crystal light valve 113B.

The light valve driver 115 applies the drive voltage to each of the pixels PL based on the projection image data received from the projector controller 130. The light valve driver 115 is, for example, a control circuit. The drive voltage is supplied by a drive source (not illustrated). The light valve driver 115 may apply the drive voltage to each of the pixels PL based on projection image data corrected by a projection controller 131 described later. When the light valve driver 115 applies the drive voltage to each of the pixels PL, each of the pixels PL is set to a light transmittance based on the projection image data. The light emitted from the light source 111 is modulated by being transmitted through the pixel region 113a. The three liquid crystal light valves 113 form color component images for the respective colored light.

The projection lens 117 combines the color component images formed by the liquid crystal light valves 113 to project the result in an enlarged manner. The projection lens 117 projects the projection image PG onto the projection surface SC. The projection image PG is a multi-color image obtained by combining the color component images.

The projector built-in speaker 120 illustrated in FIG. 2 outputs an audio based on the audio data contained in the projection image data. The projector built-in speaker 120 receives the audio data from the projector controller 130 to output an audio corresponding to the audio data. The projector 100 illustrated in FIG. 2 includes the projector built-in speaker 120, but this is not a limitation. The projector 100 may include an external speaker. The external speaker outputs an audio based on the audio data.

The projector controller 130 is a projector controller that controls each unit of the projector 100. The projector controller 130 is, as an example, a processor including a CPU. The projector controller 130 is configured with a single processor or a plurality of processors. The projector controller 130 functions as the projection controller 131 by executing firmware. The projector controller 130 may function as a functional unit other than the projection controller 131.

The projection controller 131 controls projection by the projection unit 110. The projection controller 131 causes the projection unit 110 to project the projection image PG based on the video data contained in the projection image data transmitted from the control apparatus 10. The projection controller 131 causes the projector built-in speaker 120 to output an audio based on the audio data contained in the projection image data. The projection controller 131 synchronizes the projection image PG projected from the projection unit 110 and the audio output from the projector built-in speaker 120 with each other. The projection controller 131 performs various types of correction processing such as keystone correction on the video data.

The projector memory 140 stores the firmware, various data, and so on. The projector memory 140 stores the projection image data transmitted from the control apparatus 10, correction data for correcting the video data contained in the projection image data, and so on. The projector memory 140 includes a volatile semiconductor memory such as a RAM and a nonvolatile memory such as a ROM or a flash memory.

The projector communicator 150 is a communication interface circuit that communicates with the control apparatus 10, an external apparatus, and so on. The projector communicator 150 is communicatively connected to the control apparatus 10 and so on wirelessly in accordance with a predetermined communication protocol. The projector communicator 150 includes a wireless communication port. The wireless communication port is a wireless LAN communication port or the like. The projector communicator 150 may be communicatively connected to the control apparatus 10 and so on in a wired manner. The projector communicator 150 includes a wired connector such as USB. The projector communicator 150 receives the projection image data, the control signals, and so on from the control apparatus 10. The projector communicator 150 transmits various data such as projector setting information to the control apparatus 10 and so on.

The cloud server 300 includes the web server 310, the WebSocket server 320, a server storage apparatus 330, and a server communication apparatus 340. The web server 310, the WebSocket server 320, the server storage apparatus 330, and the server communication apparatus 340 are implemented in a single apparatus or a plurality of apparatuses.

The server storage apparatus 330 stores various programs, various data, and so on. The server storage apparatus 330 stores web pages, web apps, and so on provided from various web servers 310 to the control apparatus 10 and so on. The server storage apparatus 330 is formed of a magnetic recording medium such as a hard disk drive (HDD). The server storage apparatus 330 may be configured with a volatile semiconductor memory such as a RAM, and a nonvolatile memory such as a ROM or a flash memory.

The server communication apparatus 340 is a communication interface circuit that communicates with the control apparatus 10 and so on. The server communication apparatus 340 is communicatively connected to the control apparatus 10 and so on in a wired or wireless manner in accordance with a predetermined communication protocol. The server communication apparatus 340 includes a wired connector, a wireless communication port, and so on. The wired connector is a USB connector, a LAN connector, or the like. The wireless communication port is a Wi-Fi communication port, a Bluetooth communication port, or the like. Wi-Fi and Bluetooth are registered trademarks. The server communication apparatus 340 transmits the web app and so on to the control apparatus 10. The server communication apparatus 340 receives various signals transmitted from the control apparatus 10.

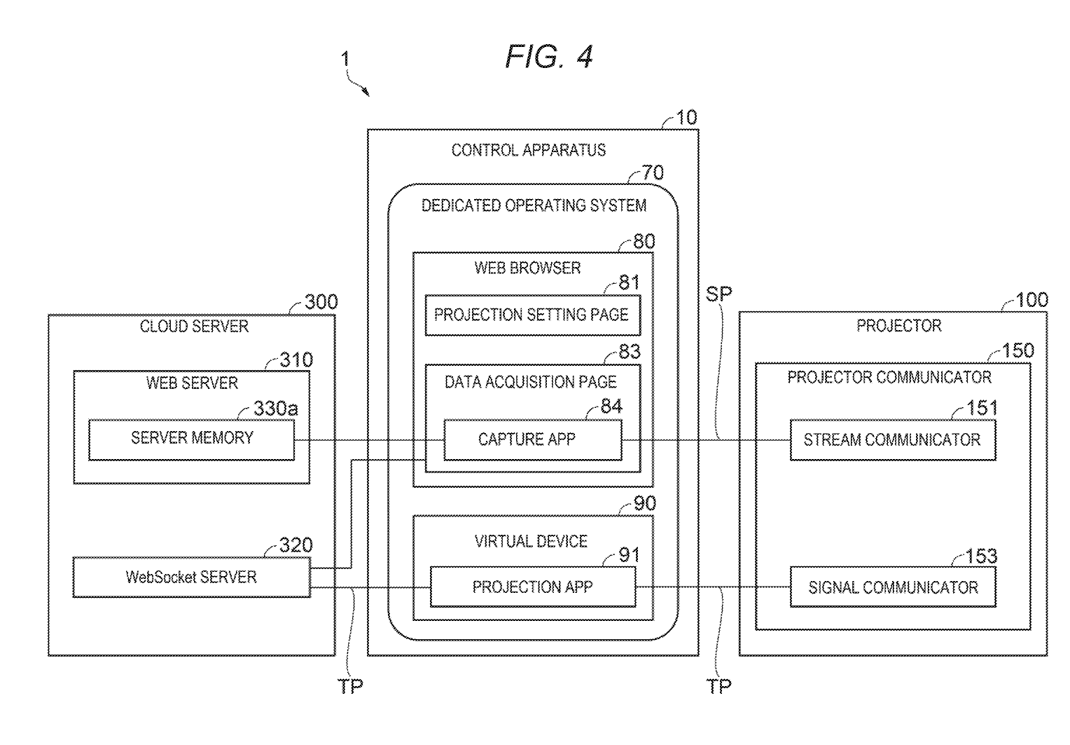

FIG. 4 illustrates a system configuration of the projection system 1. FIG. 4 illustrates the control apparatus 10, the projector 100, and the cloud server 300.

In the control apparatus 10, the dedicated operating system 70 operates. The dedicated operating system 70 is, as an example, the Chrome OS. The controller 30 of the control apparatus 10 causes the dedicated operating system 70 to operate. Applications compatible with the dedicated operating system 70 are operable on the dedicated operating system 70. The web browser 80 and the virtual device 90 operate on the dedicated operating system 70 illustrated in FIG. 4. Applications other than the web browser 80 and the virtual device 90 may operate on the dedicated operating system 70.

The web browser 80 is software to be connected to the web server 310. The web browser 80 operates on the dedicated operating system 70. The web browser 80 is, as an example, Chrome. The web browser 80 displays various web pages in a browser window BW including a tab window TW. The web browser 80 acquires the web pages from the web server 310. The web pages may include web apps that operate in the web pages. The web browser 80 displays a projection setting page 81 and a data acquisition page 83 in the browser window BW or the tab window TW. In the data acquisition page 83, the capture app 84 is activated.

The projection setting page 81 receives a mirroring start instruction operation for instructing the start of mirroring. When the user performs the mirroring start instruction operation on the projection setting page 81, the projection setting page 81 sets the projector 100 to execute mirroring. The projection setting page 81 is an example of the web page. The web browser 80 acquires the projection setting page information related to the projection setting page 81 from the web server 310. The web browser 80 displays the projection setting page 81 in the browser window BW or the tab window TW based on the projection setting page information. The projection setting page 81 corresponds to an example of a setting page.

The data acquisition page 83 causes the capture app 84 to operate to thereby acquire the shared data. The data acquisition page 83 is an example of the web page. The web browser 80 acquires data acquisition page information related to the data acquisition page 83 from the web server 310. The web browser 80 displays the data acquisition page 83 in the browser window BW or the tab window TW based on the data acquisition page information. In the data acquisition page 83, the capture app 84 is activated. The data acquisition page 83 causes the capture app 84 to operate to acquire the shared data.

The capture app 84 is activated on a data acquisition page 83 displayed on the web browser 80. The web browser 80 acquires the data acquisition page 83 including the capture app 84 from the web server 310. The capture app 84 captures, as the shared data, the generated data output from the output unit 20 of the control apparatus 10. The generated data includes video data output from the display data output unit 21. The video data is data for causing the display 15 to display the display screen DS. The video data corresponds to an example of display data. The shared data may include audio data output from the audio output unit 23. The shared data is transmitted to the projector 100 via a stream distribution path SP as the projection image data. The capture app 84 may transmit the shared data to a projection app 91. The capture app 84 corresponds to an example of a web application program.

The virtual device 90 is a virtual device that operates on the dedicated operating system 70. The virtual device 90 is an example of an emulator that operates on the dedicated operating system 70. The virtual device 90 functions as a device that causes an operating system different from the dedicated operating system 70 to operate on the dedicated operating system 70. The virtual device 90 provides a virtual environment on the dedicated operating system 70. The virtual device 90 is, as an example, a device where the Android OS operates. It becomes possible to run, on the virtual device 90, applications that operate on the operating system different from the dedicated operating system 70. The applications that operate on the operating system different from the dedicated operating system 70 are Android apps. The projection app 91 illustrated in FIG. 4 is an example of the Android app.

The projection app 91 is software that controls the projector 100. The projection app 91 is stored in advance in the memory 40. The projection app 91 causes the projector 100 to project various projection images PG. The projection app 91 transmits various control signals to the projector 100, the cloud server 300, and so on. The projection app 91 receives response signals and so on from the projector 100, the cloud server 300, and so on. The projection app 91 causes the capture app 84 to acquire the shared data. The projection app 91 causes the capture app 84 to transmit the shared data to the projector 100 as the projection image data. The projection app 91 may cause the capture app 84 to transmit the shared data to the projection app 91.

The projection app 91 controls display by the web browser 80. The projection app 91 controls a display mode of the browser window BW or the tab window TW that displays the projection setting page 81 and the data acquisition page 83. The projection app 91 controls the display mode of the browser window BW or the tab window TW to thereby cause the projector 100 to project a display screen DS desired by the user. The projection app 91 transmits, to the web browser 80, setting information for controlling the display mode of the browser window BW or the tab window TW, and so on. The projection app 91 transmits the setting information and so on to the web browser 80 directly or via the web server 310. The web browser 80 changes the display mode of the browser window BW or the tab window TW based on the setting information and so on.

The projection app 91 that operates on the virtual device 90 transmits or receives various control signals and so on to and from the dedicated operating system 70 via various application programming interfaces (API). The API is different depending on a version or the like of the operating system that operates on the virtual device 90. Depending on the version of the operating system that operates on the virtual device 90, it becomes difficult for the projection app 91 to control the projector 100 in some cases. The projection app 91 transmits, as the projection image data, the shared data to the projector 100 using the functions of the web browser 80 and the cloud server 300.

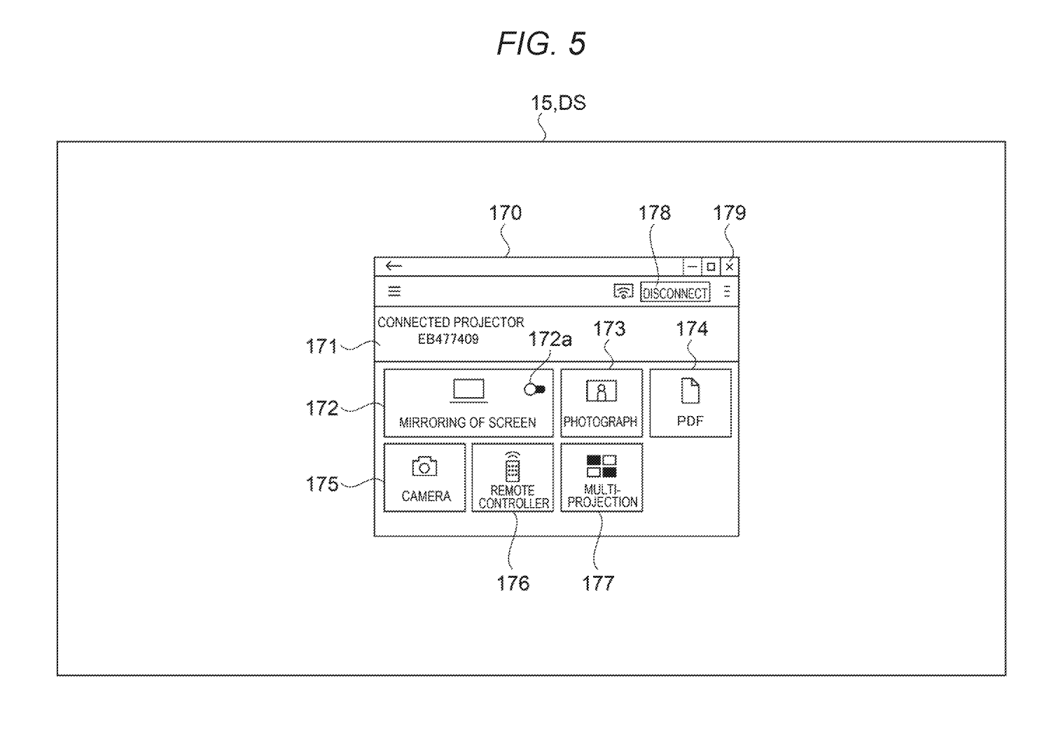

FIG. 5 illustrates an example of the display screen DS. The display screen DS is displayed on the display 15. The display screen DS illustrated in FIG. 5 represents the display screen DS at the time when the control apparatus 10 activates the projection app 91. The display screen DS includes a UI screen 170 of the projection app 91. UI is an abbreviation for a user interface.

The UI screen 170 displays a plurality of icons and so on. The UI screen 170 includes a projector name display 171, a mirroring reception icon 172, a photograph display reception icon 173, a document display reception icon 174, a camera image display reception icon 175, a remote controller function reception icon 176, a multi-projection reception icon 177, a disconnection reception icon 178, and a termination reception icon 179.

The projector name display 171 displays a projector name of the projector 100 connected to the control apparatus 10. The projector name display 171 displays the projector name based on model information or the like of the projector 100 acquired from the projector 100.

The mirroring reception icon 172 receives a mirroring instruction operation by the user. When the user executes a predetermined operation on the mirroring reception icon 172, the mirroring reception icon 172 receives the mirroring instruction operation. When the projection app 91 receives the mirroring instruction operation, the projection app 91 generates a mirroring control signal corresponding to the mirroring instruction operation. The mirroring reception icon 172 includes a switch icon 172a.

The switch icon 172a represents whether mirroring is in operation in the projector 100. By checking the display of the switch icon 172a, the user can determine whether mirroring is in operation in the projector 100. The switch icon 172a illustrated in FIG. 5 indicates that mirroring is not in operation. The switch icon 172a may receive the mirroring instruction operation by the user.

The photograph display reception icon 173 receives a photograph display instruction by the user. When the user executes a predetermined operation on the photograph display reception icon 173, the photograph display reception icon 173 receives the photograph display instruction. When the projection app 91 receives the photograph display instruction, the projection app 91 performs photograph display processing of causing the projector 100 to project a photograph image stored by the control apparatus 10. The projection app 91 transmits photograph image data for displaying the photograph image to the projector 100 to cause the projector 100 to project the photograph image as the projection image PG.

The document display reception icon 174 receives a document display instruction by the user. When the user executes a predetermined operation on the document display reception icon 174, the document display reception icon 174 receives the document display instruction. When the projection app 91 receives the document display instruction, the projection app 91 performs document display processing of causing the projector 100 to project a PDF file or the like stored by the control apparatus 10. The projection app 91 transmits, as an example, PDF data for displaying a PDF image to the projector 100 to cause the projector 100 to project the PDF image as the projection image PG.

The camera image display reception icon 175 receives a camera image display instruction by the user. When the control apparatus 10 includes an imaging device such as a camera, the camera image display reception icon 175 is operable. When the user executes a predetermined operation on the camera image display reception icon 175, the camera image display reception icon 175 receives the camera image display instruction. When the projection app 91 receives the camera image display instruction, the projection app 91 performs camera image display processing of causing the projector 100 to project a captured image captured by the imaging device. The projection app 91 transmits imaging data for displaying the captured image to the projector 100 to cause the projector 100 to project the captured image as the projection image PG.

The remote controller function reception icon 176 receives a remote controller function operation instruction by the user. When the user executes a predetermined operation on the remote controller function reception icon 176, the remote controller function reception icon 176 receives the remote controller function operation instruction. When the projection app 91 receives the remote controller function operation instruction, the projection app 91 causes a remote controller image representing a remote controller for operating the projector 100 to be displayed on the projection image PG. When the user performs an input operation on the remote controller image, control corresponding to the input operation can be performed on the projector 100.

The multi-projection reception icon 177 receives a multi-projection instruction by the user. The multi-projection reception icon 177 is operable when a plurality of projectors 100 is connected to the control apparatus 10. When the user executes a predetermined operation on the multi-projection reception icon 177, the multi-projection reception icon 177 receives the multi-projection instruction. The projection app 91 executes multi-projection of causing the plurality of projectors 100 connected to the control apparatus 10 to project the projection image PG onto the projection surface SC.

The disconnection reception icon 178 receives a disconnection instruction by the user. When the user executes a predetermined operation on the disconnection reception icon 178, the disconnection reception icon 178 receives the disconnection instruction. When the projection app 91 receives the disconnection instruction, the projection app 91 disconnects the communicative connection between the control apparatus 10 and the projector 100.

The termination reception icon 179 receives an app termination operation by the user. When the user performs a predetermined operation on the termination reception icon 179, the termination reception icon 179 receives the app termination operation. When the projection app 91 receives the app termination operation, the projection app 91 stops operating. Then, the UI screen 170 is hidden.

The stream distribution path SP illustrated in FIG. 4 is a path through which real-time communication between the web browser 80 and the projector 100 is performed. Through the stream distribution path SP, the communication is performed using, as an example, WebRTC technology. The web browser 80 can transmit the shared data to the projector 100 via the stream distribution path SP. By the web browser 80 transmitting the shared data to the projector 100 via the stream distribution path SP, the control apparatus 10 can transmit the shared data to the projector 100 without degrading the quality of the shared data. The stream distribution path SP corresponds to an example of a browser communication path.

A TCP/IP communication path TP is a path for performing communication using Transmission Control Protocol/Internet Protocol (TCP/IP). The TCP/IP communication path TP and the stream distribution path SP are communication paths different from each other. The projection app 91 transmits various control signals to the projector 100 via the TCP/IP communication path TP. The projection app 91 receives control signals from the projector 100 via the TCP/IP communication path TP. The projection app 91 may transmit the shared data to the projector 100 via the TCP/IP communication path TP. When the shared data is transmitted to the projector 100 via the TCP/IP communication path TP, there is a possibility that degradation of the quality of the shared data occurs depending on a situation of the virtual device 90. The shared data is preferably transmitted to the projector 100 via the stream distribution path SP. The TCP/IP communication path TP corresponds to an example of a signal communication path.

The projector communicator 150 of the projector 100 includes a stream communicator 151 and a signal communicator 153.

The stream communicator 151 is communicatively connected to the capture app 84 via the stream distribution path SP. The stream communicator 151 is compatible with the WebRTC technology. The stream communicator 151 receives the shared data transmitted from the capture app 84 with real-time communication.

The signal communicator 153 is communicatively connected to the projection app 91 via the TCP/IP communication path TP. The signal communicator 153 receives a control signal from the projection app 91. The signal communicator 153 transmits the control signal generated by the projector 100 to the projection app 91. By the signal communicator 153 transmitting and receiving the control signal between the projection app 91 and the projector 100, the projection app 91 can control the projector 100.

The web server 310 provided to the cloud server 300 includes a server memory 330a. The server memory 330a is a part of the server storage apparatus 330. The server memory 330a stores web page information related to various web pages. The web page information includes web app information related to various web apps. The web server 310 provides the web browser 80 with the web page information stored in the server memory 330a.

The WebSocket server 320 receives various control signals transmitted from the projection app 91 via the TCP/IP communication path TP. The control signal transmitted from the projection app 91 includes a web page request. The web page request is, as an example, a signal that instructs transmission of a web page including the web app from the web server 310 to the web browser 80. When the WebSocket server 320 receives the web page request, the WebSocket server 320 transmits the web page request to the web server 310. The web server 310 transmits the web page information to the web browser 80 based on the web page request.

In the projection system 1 shown in FIG. 4, the web server 310 provided to the cloud server 300 provides various web pages, but this is not a limitation. The projection setting page information related to the projection setting page 81 and the data acquisition page information related to the data acquisition page 83 may be stored in advance in the memory 40 of the control apparatus 10 or the projector memory 140 of the projector 100. The projection setting page information and the data acquisition page information are examples of the web page information. When the projection setting page information and so on are stored in the memory 40, the web browser 80 acquires the projection setting page information and so on from the memory 40. At this time, the controller 30 has a virtual server function equivalent to that of the cloud server 300. When the projection setting page information and so on are stored in the projector memory 140, the web browser 80 acquires the projection setting page information and so on from the projector 100. At this time, the projector controller 130 has a virtual server function equivalent to that of the cloud server 300. When the projection setting page information and so on are stored in advance in the memory 40 or the projector memory 140, the projection system 1 is not required to include the cloud server 300.

### First Embodiment

A first embodiment shows a control flow and display screens DS when the web browser 80 is not activated before the projection app 91 receives a mirroring instruction operation by the user. In the first embodiment, the projection app 91 activates the web browser 80. After activating the web browser 80, the projection app 91 causes the projector 100 to execute mirroring of the display screen DS using the web browser 80.

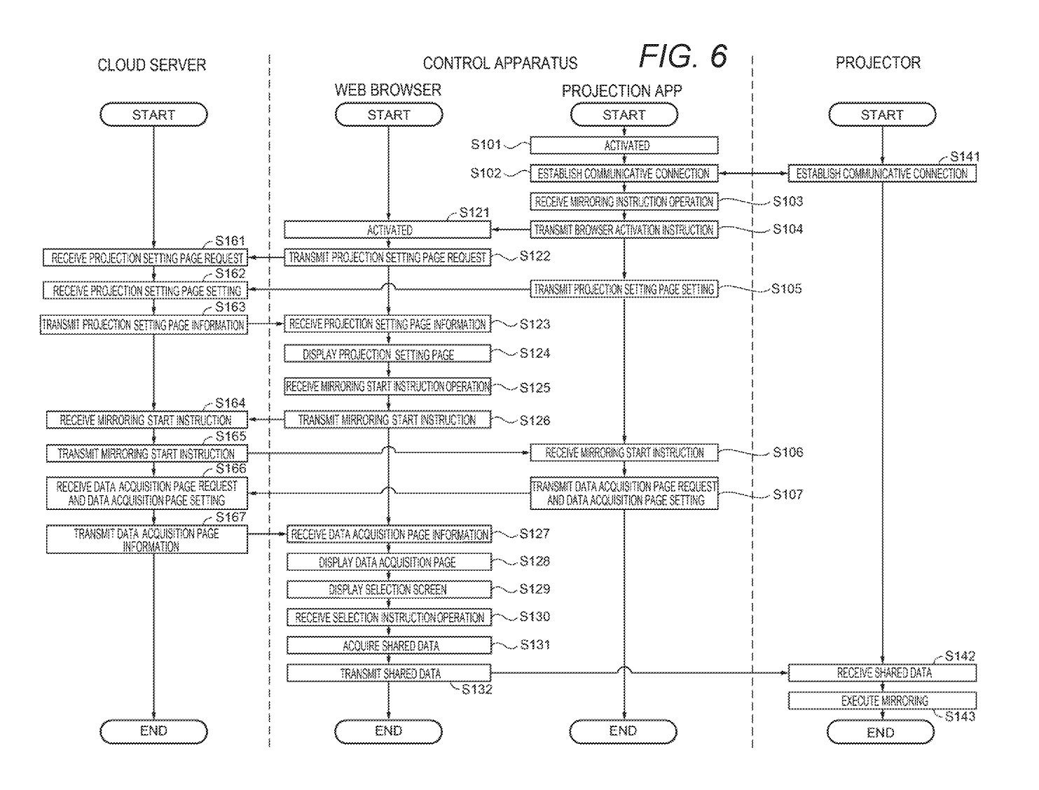

FIG. 6 illustrates a control flow executed in the projection system 1. FIG. 6 illustrates a control flow executed by the control apparatus 10, the projector 100, and the cloud server 300. The control flow executed by the control apparatus 10 corresponds to an example of an information processing method. The control apparatus 10 executes the control flow to thereby execute mirroring of causing the projector 100 to project the display screen DS displayed on the display 15.

The projection app 91 is activated in step S101. When the input unit 17 of the control apparatus 10 receives a predetermined operation by the user, the control apparatus 10 activates the projection app 91. The projection app 91 runs on the virtual device 90. The projection app 91 is executed on a virtual environment.

After being activated, the projection app 91 establishes communicative connection to the projector 100 in step S102. The projection app 91 transmits, to the projector 100, a control signal such as a connection request via the TCP/IP communication path TP to establish the communicative connection to the projector 100.

After the projection app 91 is activated, the projector 100 establishes communicative connection to the control apparatus 10 in step S141. The projector 100 receives the control signal such as the connection request from the projection app 91 via the TCP/IP communication path TP. The projector 100 transmits various data such as the model information to establish the communicative connection to the control apparatus 10. When the communicative connection to the control apparatus 10 is established, the projector 100 can receive various data from the control apparatus 10.

After establishing the communicative connection to the projector 100, the projection app 91 receives the mirroring instruction operation in step S103. When the projection app 91 is activated, the projection app 91 causes the display 15 to display the UI screen 170. When the user executes the mirroring instruction operation on the mirroring reception icon 172 in the UI screen 170 displayed on the display 15, the mirroring reception icon 172 receives the mirroring instruction operation.

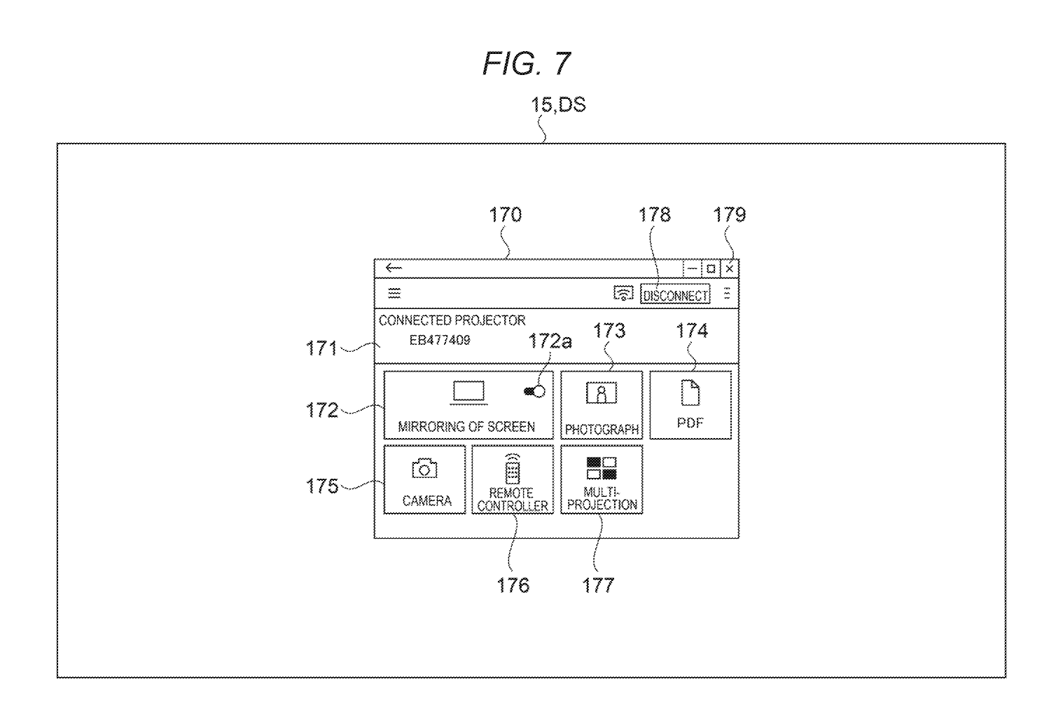

FIG. 7 illustrates an example of the display screen DS. The display screen DS is displayed on the display 15. The display screen DS shown in FIG. 7 includes the UI screen 170 of the projection app 91. The display screen DS shown in FIG. 7 represents the display screen DS when the user executes the mirroring instruction operation on the mirroring reception icon 172.

When the user executes the mirroring instruction operation on the mirroring reception icon 172, the display mode of the switch icon 172a is changed as illustrated in FIG. 7. The switch icon 172a slides to the right. The user can confirm that the mirroring reception icon 172 has received the mirroring instruction operation by confirming the position of the switch icon 172a.

When receiving the mirroring instruction operation, the projection app 91 activates the web browser 80 to perform projection setting page display processing of displaying the projection setting page 81 in the browser window BW of the web browser 80 in steps on and after step S104. The mirroring instruction operation corresponds to an example of a display operation.

As shown in FIG. 6, when receiving the mirroring instruction operation, the projection app 91 transmits a browser activation instruction to the controller 30 in step S104. The projection app 91 transmits the browser activation instruction to the browser controller 31 of the controller 30 based on the mirroring instruction operation. The browser controller 31 receives the browser activation instruction.

When the projection app 91 transmits the browser activation instruction, the web browser 80 is activated in step S121. When receiving the browser activation instruction from the projection app 91, the browser controller 31 executes browser activation processing of activating the web browser 80. The browser activation processing corresponds to an example of activation processing. The web browser 80 is activated based on the mirroring instruction operation.

After being activated, the web browser 80 transmits a projection setting page request to the cloud server 300 in step S122. The projection setting page request is a request for causing the web browser 80 to display the projection setting page 81. The projection setting page request includes a projection setting page address of the projection setting page 81. The projection app 91 transmits the projection setting page request to thereby display the projection setting page window 81w including the projection setting page 81 in the browser window BW of the web browser 80. The projection setting page window 81w corresponds to an example of a setting window. The projection app 91 causes the web browser 80 to display the projection setting page window 81w based on the mirroring instruction operation. The projection app 91 may transmit the projection setting page request directly to the cloud server 300 or may transmit the projection setting page request to the cloud server 300 via the web browser 80.

When the projection app 91 transmits the browser activation instruction, the projection app 91 transmits projection setting page setting to the cloud server 300 in step S105. The projection setting page setting is display setting when the web browser 80 displays the projection setting page window 81w. The projection app 91 transmits the projection setting page setting to the cloud server 300 to thereby designate the display size of the browser window BW when the web browser 80 displays the projection setting page window 81w. The projection app 91 transmits the projection setting page setting to the cloud server 300 to thereby display the projection setting page window 81w in a first display size. The first display size corresponds to an example of a first size.

When the projection app 91 causes the projection setting page 81 to be displayed in the browser window BW that is displayed when the web browser 80 is activated, the projection app 91 is not required to transmit the projection setting page setting to the cloud server 300. The projection setting page request may include the projection setting page setting. When the projection setting page request includes the projection setting page setting, step S105 is omitted from the flow.

When the web browser 80 transmits the projection setting page request, the cloud server 300 receives the projection setting page request in step S161. The web server 310 provided to the cloud server 300 receives the projection setting page request. The web server 310 acquires the projection setting page information based on the projection setting page address contained in the projection setting page request. The projection setting page information is information for causing the web browser 80 to display the projection setting page 81.

When the projection app 91 transmits the projection setting page setting, the cloud server 300 receives the projection setting page information in step S162.

After receiving the projection setting page request and the projection setting page setting, the cloud server 300 transmits the projection setting page information to the web browser 80 in step S163. The web server 310 provided to the cloud server 300 transmits the projection setting page information to the web browser 80. When the projection setting page request includes the projection setting page setting, the web server 310 transmits the projection setting page setting to the web browser 80.

When the cloud server 300 transmits the projection setting page information, the web browser 80 receives the projection setting page information in step S123.

When receiving the projection setting page information, the web browser 80 displays the projection setting page 81 in step S124. The browser controller 31 executes projection setting page display processing of displaying the projection setting page window 81w including the projection setting page 81 based on the projection setting page information. The projection setting page display processing corresponds to an example of the display processing. The web browser 80 displays the projection setting page window 81w in the first display size.

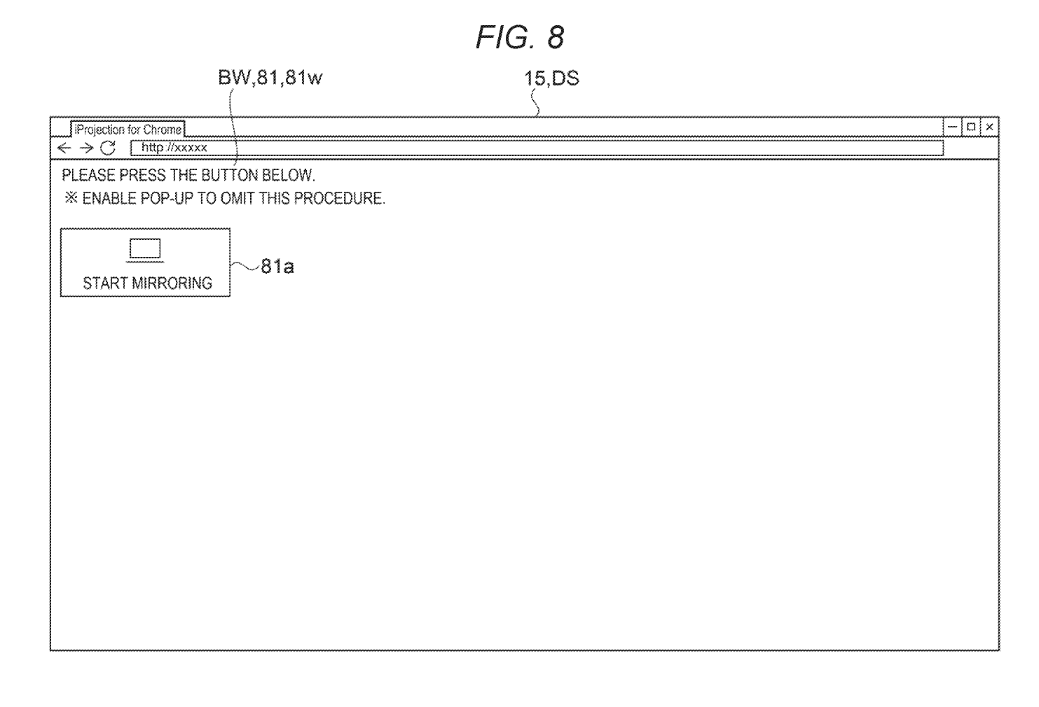

FIG. 8 illustrates an example of the display screen DS. The display screen DS is displayed on the display 15. The display screen DS shown in FIG. 8 represents the display screen DS that is displayed when the browser controller 31 executes the projection setting page display processing based on the projection setting page information and the projection setting page setting. The display screen DS illustrated in FIG. 8 displays a browser window BW.

The browser window BW shown in FIG. 8 is the projection setting page window 81w that displays the projection setting page 81. The projection setting page 81 displayed in the projection setting page window 81w receives an input operation related to mirroring of projecting the display screen DS. The projection setting page window 81w includes a mirroring start icon 81a.

The mirroring start icon 81a receives an input operation by the user. When the user performs a predetermined operation on the mirroring start icon 81a, the projection setting page 81 receives a mirroring start instruction operation. The mirroring start instruction operation is an instruction operation for causing the projector 100 to project the display screen DS. The mirroring start instruction operation corresponds to an example of a projection instruction operation.

The projection setting page window 81w is displayed in the first display size. The first display size is, as an example, a full-screen size of the display 15. The first display size is not limited to the full-screen size of the display 15. The first display size is not limited as long as the mirroring start icon 81a can be displayed.

As illustrated in FIG. 6, after displaying the projection setting page 81, the web browser 80 receives the mirroring start instruction operation in step S125. When the user performs the mirroring start instruction operation on the mirroring start icon 81a, the projection setting page 81 receives the mirroring start instruction operation. The web browser 80 transmits a signal corresponding to the mirroring start instruction operation to the projection app 91.

When the web browser 80 receives the mirroring start instruction operation, the web browser 80 transmits the mirroring start instruction to the cloud server 300 in step S126.

When the web browser 80 transmits the mirroring start instruction, the cloud server 300 receives the mirroring start instruction in step S164.

When the cloud server 300 receives the mirroring start instruction, the cloud server 300 transmits the mirroring start instruction to the projection app 91 in step S165.

When the cloud server 300 transmits the mirroring start instruction, the projection app 91 receives the mirroring start instruction in step S106.

When receiving the mirroring start instruction, the projection app 91 transmits a data acquisition page request and data acquisition page setting to the cloud server 300 in step S107. The data acquisition page request is a request for causing the web browser 80 to display the data acquisition page 83. The data acquisition page request includes a data acquisition page address of the data acquisition page 83. The projection app 91 causes the web browser 80 to display a data acquisition page window 83w including the data acquisition page 83 by transmitting the data acquisition page request. The data acquisition page window 83w corresponds to an example of an acquisition window. The projection app 91 causes the web browser 80 to display the data acquisition page window 83w based on the mirroring start instruction operation.

The data acquisition page setting is display setting when the web browser 80 displays the data acquisition page window 83w. The projection app 91 transmits the data acquisition page setting to the cloud server 300 to thereby designate the display size of the browser window BW when the web browser 80 displays the data acquisition page window 83w. The projection app 91 transmits the data acquisition page setting to the cloud server 300 to thereby cause the web browser 80 to display the data acquisition page window 83w in a second display size smaller than the first display size. The second display size corresponds to an example of a second size.

When the projection app 91 transmits the data acquisition page request and the data acquisition page setting, the cloud server 300 receives the data acquisition page request and the data acquisition page setting in step S166. The web server 310 provided to the cloud server 300 receives the data acquisition page request and the data acquisition page setting. The web server 310 acquires the data acquisition page information based on the data acquisition page address contained in the data acquisition page request. The data acquisition page information is information for causing the web browser 80 to display the data acquisition page 83.

After receiving the data acquisition page request and the data acquisition page setting, the cloud server 300 transmits the data acquisition page information to the web browser 80 in step S167. The web server 310 provided to the cloud server 300 transmits the data acquisition page information to the web browser 80.

When the cloud server 300 transmits the data acquisition page information, the web browser 80 receives the data acquisition page information in step S127.

When receiving the data acquisition page information, the web browser 80 displays the data acquisition page 83 in step S128. The browser controller 31 executes acquisition page display processing of displaying the data acquisition page window 83w including the data acquisition page 83 based on the data acquisition page information. The acquisition page display processing corresponds to an example of window display processing. The web browser 80 displays the data acquisition page window 83w in the second display size smaller than the first display size by the acquisition page display processing.

After displaying the data acquisition page 83, the web browser 80 displays a selection screen 180 on the display 15 in step S129. The selection screen 180 is a screen for allowing the user to select the display screen DS to be projected by the projector 100. When displaying the selection screen 180, the web browser 80 may change the display size of the projection setting page window 81w.

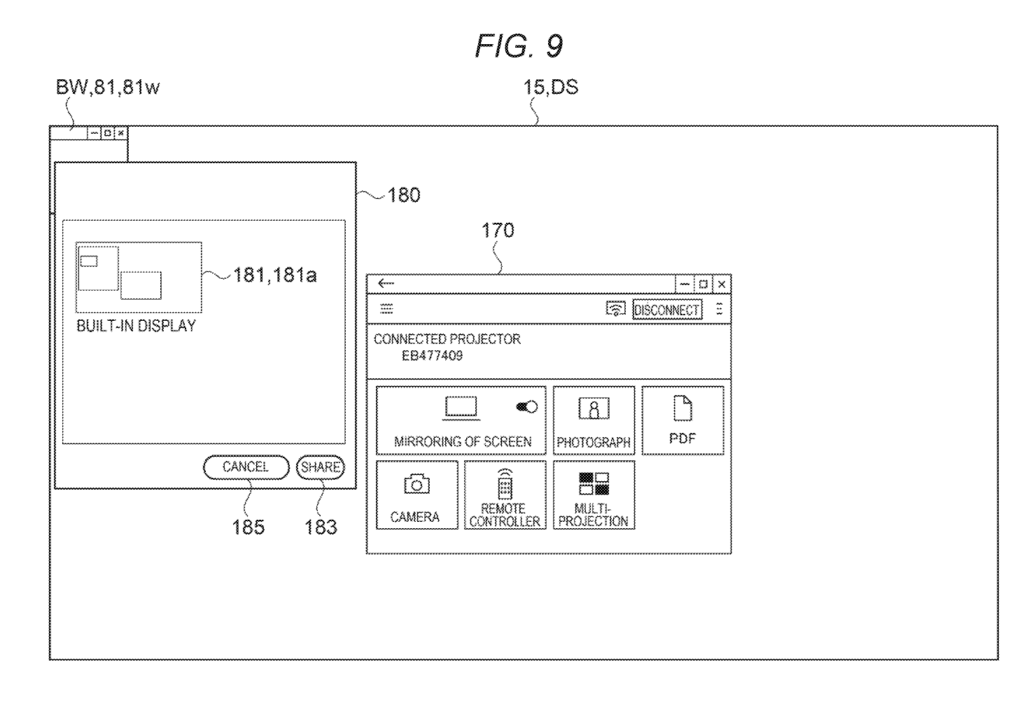

FIG. 9 illustrates an example of the display screen DS. The display screen DS is displayed on the display 15. The display screen DS shown in FIG. 9 represents the display screen DS when the web browser 80 displays the selection screen 180. The display screen DS illustrated in FIG. 9 displays the UI screen 170, the selection screen 180, and the browser window BW.

The selection screen 180 includes a selection image 181, a share icon 183, and a share cancel icon 185. The selection screen 180 displays one or more selection images 181. The selection screen 180 illustrated in FIG. 9 includes a first selection image 181a as the selection image 181. When the selection screen 180 displays a plurality of selection images 181, the plurality of selection images 181 is displayed side by side in the selection screen 180.

The selection image 181 receives an input operation by the user. The selection image 181 is a captured image of the display screen DS projected by the projector 100. The first selection image 181a is an image obtained by reducing the display screen DS shown in FIG. 9. When the user performs a predetermined selection operation on the selection image 181, the selection image 181 subjected to the selection operation is selected as the display screen DS to be projected by the projector 100.

The share icon 183 receives an input operation by the user. When the user performs a predetermined operation on the share icon 183, the projection app 91 receives a selection instruction operation. The selection image 181 subjected to the selection operation is selected as the display screen DS to be projected by the projector 100.

The share cancel icon 185 receives an input operation by the user. When the user performs a predetermined operation on the share cancel icon 185, the selection screen 180 is hidden, and mirroring is canceled. The control apparatus 10 does not transmit the shared data to the projector 100.

The UI screen 170 is displayed on the display screen DS when the selection screen 180 is displayed on the display screen DS. The selection screen 180 illustrated in FIG. 9 is displayed at a position not overlapping the UI screen 170, but may be displayed at a position overlapping the UI screen 170. The selection screen 180 is preferably displayed at a position not overlapping the UI screen 170.

As shown in FIG. 9, when the selection screen 180 is displayed on the display screen DS, the projection setting page window 81w is preferably displayed in a reduced size. When the selection screen 180 is displayed on the display screen DS, the web browser 80 is controlled to display the projection setting page window 81w in a reduced size. By displaying the projection setting page window 81w in a reduced size, the visibility of the selection screen 180 is improved.

When the selection screen 180 is displayed on the display screen DS, the projection setting page window 81w may be hidden. After displaying the data acquisition page 83, the web browser 80 causes the browser controller 31 to execute setting window hiding processing of hiding the projection setting page window 81w. The browser controller 31 performs the setting window hiding processing to hide the projection setting page window 81w. The setting window hiding processing corresponds to an example of window hiding processing. By hiding the projection setting page window 81w, multiple operations and erroneous operations on the projection setting page window 81w by the user are prevented.

As illustrated in FIG. 6, after displaying the selection screen 180, the web browser 80 receives the selection instruction operation in step S130. When the user performs a predetermined operation on the share icon 183 in the selection screen 180, the web browser 80 receives the selection instruction operation. When the web browser 80 receives the selection instruction operation, the web browser 80 hides the selection screen 180.

When receiving the selection instruction operation, the web browser 80 acquires the shared data in step S131. The web browser 80 acquires generated data output from the output unit 20 as the shared data due to a function of the capture app 84 operating in the data acquisition page 83. The shared data includes the video data output from the display data output unit 21. The video data is data for displaying the display screen DS displayed on the display 15. The shared data may include the audio data output from the audio output unit 23.

When acquiring the shared data, the web browser 80 displays the data acquisition page window 83w in the second display size by the acquisition page display processing. By displaying the data acquisition page window 83w in the second display size, the web browser 80 can reduce an occupancy of the data acquisition page window 83w in the display screen DS. The user can visually recognize other portions without being hindered by the data acquisition page window 83w.

When the web browser 80 acquires the shared data, the web browser 80 transmits the shared data to the projector 100 in step S132. The web browser 80 executes shared data transmission processing of transmitting the shared data based on the mirroring start instruction operation to transmit the shared data to the projector 100 as the projection image data. The shared data transmission processing corresponds to an example of data transmission processing. The web browser 80 transmits the shared data to the projector 100 via the stream distribution path SP.

When the web browser 80 transmits the shared data to the projector 100, the projector 100 receives the shared data in step S142. The projector communicator 150 of the projector 100 receives the shared data transmitted via the stream distribution path SP. The projector controller 130 acquires the shared data via the projector communicator 150.

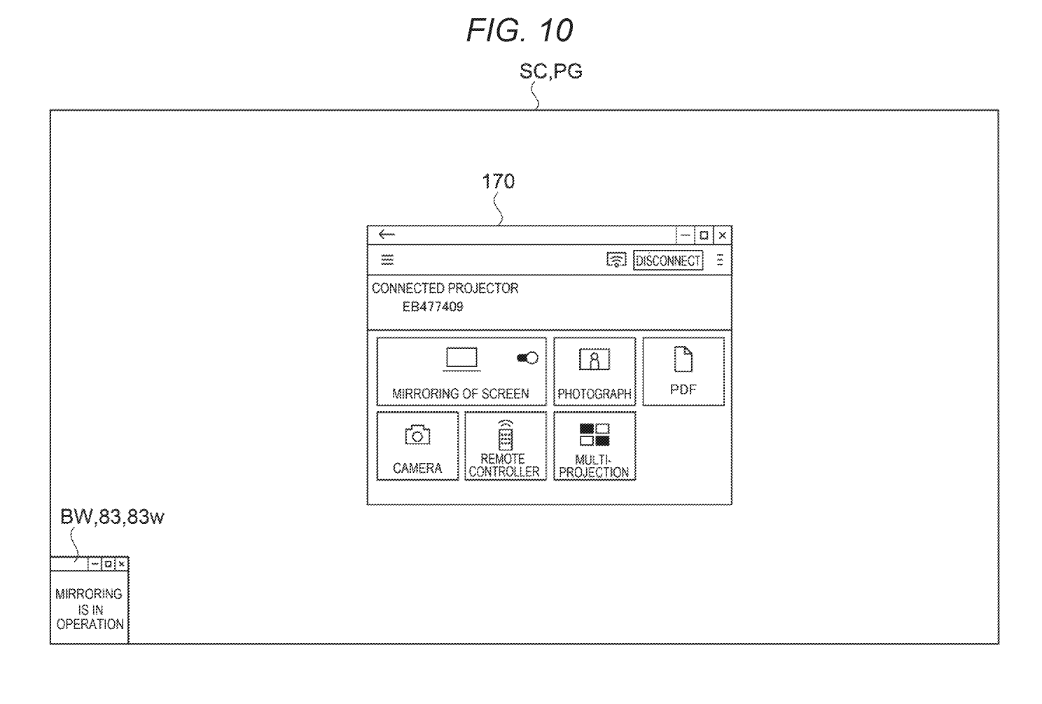

When receiving the shared data, the projector 100 executes mirroring in step S143. The projector 100 acquires the video data contained in the shared data. The projection controller 131 of the projector controller 130 transmits the video data to the projection unit 110. The projection controller 131 causes the projection unit 110 to project the video data. The projection unit 110 projects the projection image PG based on the video data onto the projection surface SC. When audio data is contained in the shared data, the projector 100 acquires the audio data contained in the shared data. The projection controller 131 transmits the audio data to the projector built-in speaker 120. The projector built-in speaker 120 outputs an audio based on the audio data. Based on the shared data including the video data and the audio data, the projector 100 displays the display screen DS displayed on the display 15 of the control apparatus 10, and outputs the audio based on the audio data. Based on the shared data including the video data, the projector 100 executes mirroring of projecting the display screen DS shown in FIG. 10.

FIG. 10 shows the projection image PG projected on the projection surface SC. FIG. 10 shows the projection image PG projected on the projection surface SC when the projector 100 executes mirroring. The projection image PG is the same image as that of the display screen DS displayed on the display 15. The display screen DS having the same image as the projection image PG is displayed on the display 15.

The projection image PG includes the UI screen 170 and the browser window BW. The browser window BW is the data acquisition page window 83w including the data acquisition page 83. The data acquisition page window 83w is displayed in the second display size smaller than the first display size. Since the data acquisition page window 83w is displayed in the second display size, it becomes easy for the user to visually recognize other images than the data acquisition page window 83w. In the projection image PG shown in FIG. 10, it is easy for the user to visually recognize the UI screen 170. The display screen DS having the same image as the projection image PG shown in FIG. 10 is displayed on the display 15. It is easy for the user to visually recognize the UI screen 170, and it is easy to perform an input operation on the UI screen 170.

The control flow of the control apparatus 10 includes establishing the communicative connection to the projector 100, receiving the mirroring instruction operation of causing the web browser 80 to display the projection setting page 81 for setting the projector 100, executing the projection setting page display processing of displaying the projection setting page window 81w including the projection setting page 81 in a first display size on the display screen DS based on the mirroring instruction operation, receiving the mirroring start instruction operation of causing the projector 100 to project the display screen DS on the projection setting page 81, and executing, based on the mirroring start instruction operation, the acquisition page display processing of displaying the data acquisition page window 83w for acquiring the video data for displaying the display screen DS in the second display size smaller than the first display size and the shared data transmission processing of transmitting the video data to the projector 100 via the data acquisition page window 83w.

By the control apparatus 10 displaying the data acquisition page window 83w in the second display size, it becomes easy for the user to visually recognize other images than the data acquisition page window 83w.

The control flow of the control apparatus 10 includes executing the browser activation processing of activating the web browser 80 based on the mirroring instruction operation when the web browser 80 is not activated before receiving the mirroring instruction operation, wherein the projection setting page display processing is to display the projection setting page window 81w including the projection setting page 81 in the first display size in the web browser 80 activated.

The control apparatus 10 can activate the web browser 80 to display the projection setting page 81 in the browser window BW based on the mirroring instruction operation.

The control flow of the control apparatus 10 preferably includes the setting window hiding processing of closing the projection setting page window 81w based on the mirroring start instruction operation.

By hiding the projection setting page window 81w, multiple operations and erroneous operations on the projection setting page window 81w by the user are prevented.

The projection system 1 includes the projector 100 and the control apparatus 10 on which the web browser 80 operates. The control apparatus 10 executes establishing the communicative connection to the projector 100, receiving the mirroring instruction operation of causing the web browser 80 to display the projection setting page 81 for setting the projector 100, performing the projection setting page display processing of displaying the projection setting page window 81w including the projection setting page 81 in a first display size on the display screen DS based on the mirroring instruction operation, receiving the mirroring start instruction operation of causing the projector 100 to project the display screen DS on the projection setting page 81, performing, based on the mirroring start instruction operation, the acquisition page display processing of displaying the data acquisition page window 83w for acquiring the video data for displaying the display screen DS in the second display size smaller than the first display size and the shared data transmission processing of transmitting the video data to the projector 100 via the data acquisition page window 83w, and transmitting the video data to the projector 100. The projector 100 executes receiving the video data from the control apparatus 10, and projecting the display screen DS based on the video data.

By the control apparatus 10 displaying the data acquisition page window 83w in the second display size, it becomes easy for the user to visually recognize other images than the data acquisition page window 83w on the display 15 or the projection surface SC.

### Second Embodiment

A second embodiment shows a control flow and display screens DS when the web browser 80 is activated before the projection app 91 receives a mirroring instruction operation by the user. In the second embodiment, after activating the web browser 80, the projection app 91 causes the projector 100 to execute mirroring of the display screen DS using the web browser 80 that has already been activated.

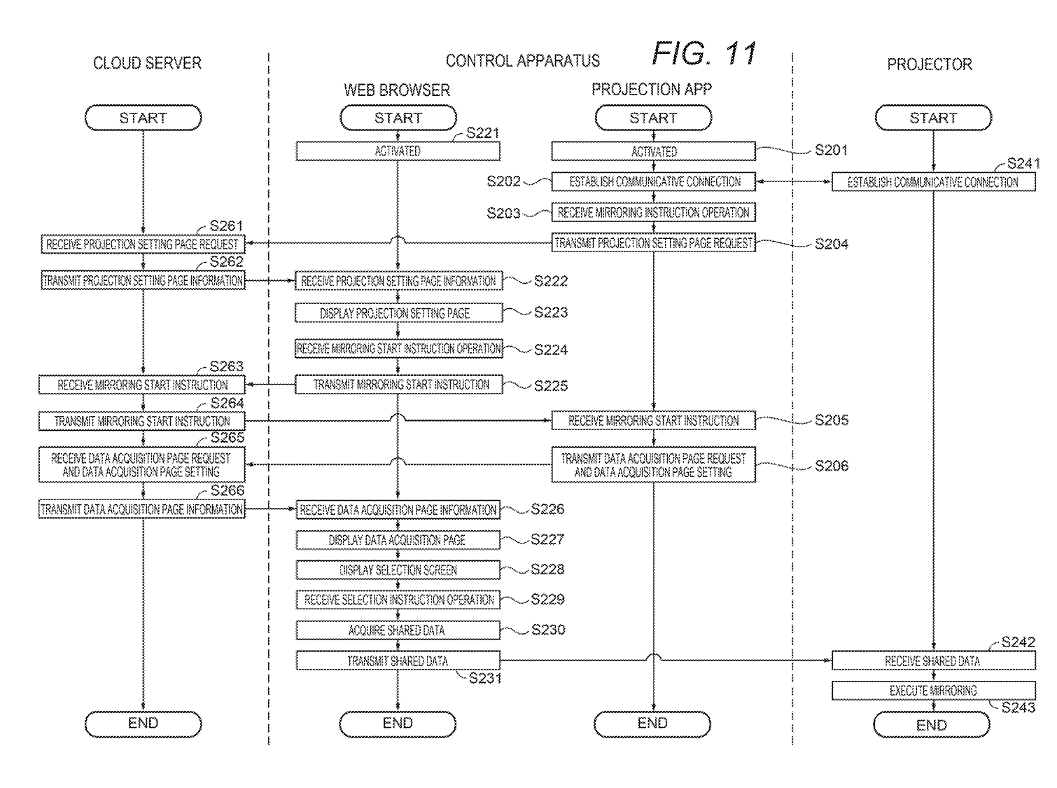

FIG. 11 illustrates a control flow executed in the projection system 1. FIG. 11 shows a control flow executed in the control apparatus 10, the projector 100, and the cloud server 300. The control apparatus 10 executes the control flow to thereby execute mirroring of causing the projector 100 to project the display screen DS displayed on the display 15.

The web browser 80 is activated in step S221. When the user performs a predetermined input operation using the input unit 17, the browser controller 31 receives the browser activation instruction and then executes the browser activation processing of activating the web browser 80. The web browser 80 is activated before the projection app 91 receives the mirroring instruction operation.

The projection app 91 is activated in step S201. When the input unit 17 of the control apparatus 10 receives a predetermined operation by the user, the control apparatus 10 activates the projection app 91. The projection app 91 runs on the virtual device 90. The projection app 91 is executed on a virtual environment.

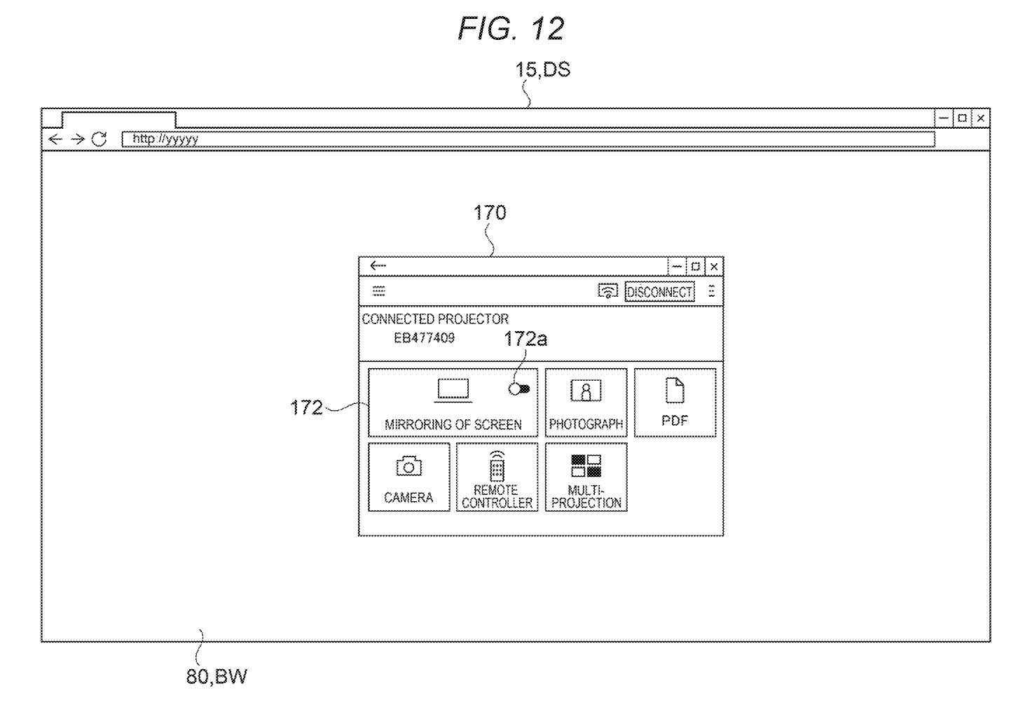

FIG. 12 illustrates an example of the display screen DS. The display screen DS is displayed on the display 15. The display screen DS illustrated in FIG. 12 indicates the display screen DS at the time when the control apparatus 10 launches the projection app 91. The display screen DS includes the browser window BW of the web browser 80 and the UI screen 170 of the projection app 91. When the projection app 91 is activated, the UI screen 170 is displayed on the browser window BW as shown in FIG. 12.

As shown in FIG. 11, after being activated, the projection app 91 establishes the communicative connection to the projector 100 in step S202. The projection app 91 transmits, to the projector 100, a control signal such as a connection request via the TCP/IP communication path TP to establish the communicative connection to the projector 100.

After the projection app 91 is activated, the projector 100 establishes communicative connection to the control apparatus 10 in step S241. The projector 100 receives the control signal such as the connection request from the projection app 91 via the TCP/IP communication path TP. The projector 100 transmits various data such as the model information to establish the communicative connection to the control apparatus 10.

After establishing the communicative connection to the projector 100, the projection app 91 receives the mirroring instruction operation in step S203. When the projection app 91 is activated, the projection app 91 causes the display 15 to display the UI screen 170 as shown in FIG. 12. When the user executes the mirroring instruction operation on the mirroring reception icon 172 in the UI screen 170 displayed on the display 15, the mirroring reception icon 172 receives the mirroring instruction operation.

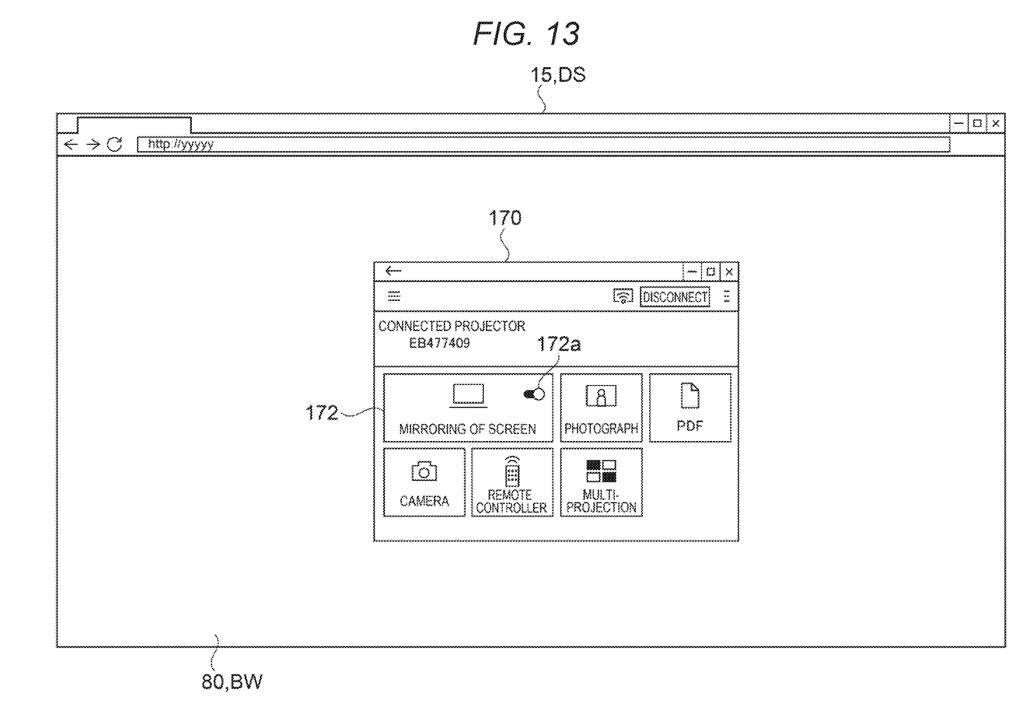

FIG. 13 illustrates an example of the display screen DS. The display screen DS is displayed on the display 15. The display screen DS illustrated in FIG. 13 includes the browser window BW of the web browser 80 and the UI screen 170 of the projection app 91. The display screen DS shown in FIG. 13 represents the display screen DS when the user executes the mirroring instruction operation on the mirroring reception icon 172.

When the user executes the mirroring instruction operation on the mirroring reception icon 172, the display mode of the switch icon 172a is changed as illustrated in FIG. 13. The switch icon 172a slides to the right.

As shown in FIG. 11, when receiving the mirroring instruction operation, the projection app 91 transmits the projection setting page request to the cloud server 300 in step S204. The projection app 91 transmits the projection setting page request to thereby display the projection setting page 81 in the tab window TW of the web browser 80. The projection setting page window 81w including the projection setting page 81 is displayed as the tab window TW. The projection app 91 causes the projection setting page window 81w to be displayed as the tab window TW based on the mirroring instruction operation. The projection app 91 may transmit the projection setting page request directly to the cloud server 300 or may transmit the projection setting page request to the cloud server 300 via the web browser 80.

When the projection app 91 transmits the projection setting page request, the cloud server 300 receives the projection setting page request in step S261. The web server 310 provided to the cloud server 300 receives the projection setting page request. The web server 310 acquires the projection setting page information based on the projection setting page address contained in the projection setting page request.

After receiving the projection setting page request, the cloud server 300 transmits the projection setting page information to the web browser 80 in step S262. The web server 310 provided to the cloud server 300 transmits the projection setting page information to the web browser 80.

When the cloud server 300 transmits the projection setting page information, the web browser 80 receives the projection setting page information in step S222.

When receiving the projection setting page information, the web browser 80 displays the projection setting page 81 in step S223. The browser controller 31 executes projection setting page display processing of displaying, as the tab window TW, the projection setting page window 81w including the projection setting page 81 based on the projection setting page information. The web browser 80 displays, as the tab window TW, the projection setting page window 81w in the first display size.

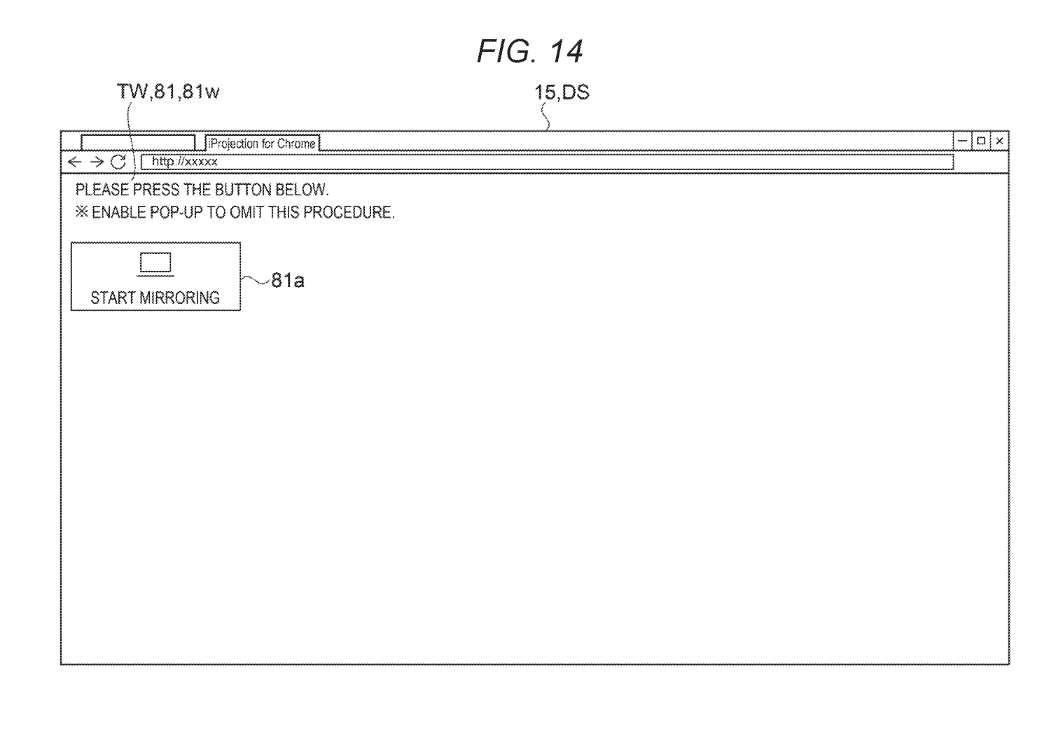

FIG. 14 illustrates an example of the display screen DS. The display screen DS is displayed on the display 15. The display screen DS shown in FIG. 14 represents the display screen DS that is displayed when the browser controller 31 executes the projection setting page display processing based on the projection setting page information. The display screen DS shown in FIG. 14 displays the tab window TW.

The web browser 80 shown in FIG. 14 displays, as the tab window TW, the projection setting page window 81w displaying the projection setting page 81. The projection setting page 81 displayed in the projection setting page window 81w receives an input operation related to mirroring of projecting the display screen DS. The projection setting page window 81w includes a mirroring start icon 81a.

The projection setting page window 81w displayed as the tab window TW is displayed in the first display size. The first display size is, as an example, a full-screen size of the display 15. The first display size is a display size of the browser window BW when the web browser 80 is activated in step S221.

As illustrated in FIG. 11, after displaying the projection setting page 81, the web browser 80 receives the mirroring start instruction operation in step S224. When the user performs the mirroring start instruction operation on the mirroring start icon 81a, the projection setting page 81 receives the mirroring start instruction operation.

When the web browser 80 receives the mirroring start instruction operation, the web browser 80 transmits the mirroring start instruction to the cloud server 300 in step S225.

When the web browser 80 transmits the mirroring start instruction, the cloud server 300 receives the mirroring start instruction in step S263.

When the cloud server 300 receives the mirroring start instruction, the cloud server 300 transmits the mirroring start instruction to the projection app 91 in step S264.

When the cloud server 300 transmits the mirroring start instruction, the projection app 91 receives the mirroring start instruction in step S205.

When receiving the mirroring start instruction, the projection app 91 transmits a data acquisition page request and data acquisition page setting to the cloud server 300 in step S206. The projection app 91 causes the data acquisition page window 83w including the data acquisition page 83 to be displayed as the tab window TW by transmitting the data acquisition page request and the data acquisition page setting. The web browser 80 displays the data acquisition page window 83w as the tab window TW based on the mirroring start instruction operation.

The data acquisition page setting is display setting when the web browser 80 displays the data acquisition page window 83w as the tab window TW. The projection app 91 transmits the data acquisition page setting to the cloud server 300 to thereby designate the display size of the tab window TW when the web browser 80 displays the data acquisition page window 83w as the tab window TW. The projection app 91 transmits the data acquisition page setting to the cloud server 300 to thereby display, in the second display size smaller than the first display size, the data acquisition page window 83w displayed as the tab window TW.

When the projection app 91 transmits the data acquisition page request and the data acquisition page setting, the cloud server 300 receives the data acquisition page request and the data acquisition page setting in step S265. The web server 310 provided to the cloud server 300 receives the data acquisition page request and the data acquisition page setting. The web server 310 acquires the data acquisition page information based on the data acquisition page address contained in the data acquisition page request.

After receiving the data acquisition page request and the data acquisition page setting, the cloud server 300 transmits the data acquisition page information to the web browser 80 in step S266. The web server 310 provided to the cloud server 300 transmits the data acquisition page information to the web browser 80.

When the cloud server 300 transmits the data acquisition page information, the web browser 80 receives the data acquisition page information in step S226.

When receiving the data acquisition page information, the web browser 80 displays the data acquisition page 83 as the tab window TW in step S227. The browser controller 31 executes acquisition page display processing of displaying the data acquisition page window 83w including the data acquisition page 83 based on the data acquisition page information. The web browser 80 displays the data acquisition page window 83w as the tab window TW in the second display size smaller than the first display size by the acquisition page display processing.

When the data acquisition page window 83w is displayed as the tab window TW on the display screen DS, the projection setting page window 81w is preferably hidden. When receiving the mirroring start instruction operation, the web browser 80 causes the browser controller 31 to execute setting window tab hiding processing of closing the projection setting page window 81w displayed as the tab window TW. The setting window tab hiding processing corresponds to an example of tab window hiding processing. The browser controller 31 performs the setting window tab hiding processing to close the projection setting page window 81w. By closing the projection setting page window 81w, multiple operations and erroneous operations on the projection setting page window 81w by the user are prevented.

After displaying the data acquisition page 83, the web browser 80 displays a selection screen 180 on the display 15 in step S228. When displaying the selection screen 180, the web browser 80 may change the display size of the projection setting page window 81w displayed as the tab window TW.

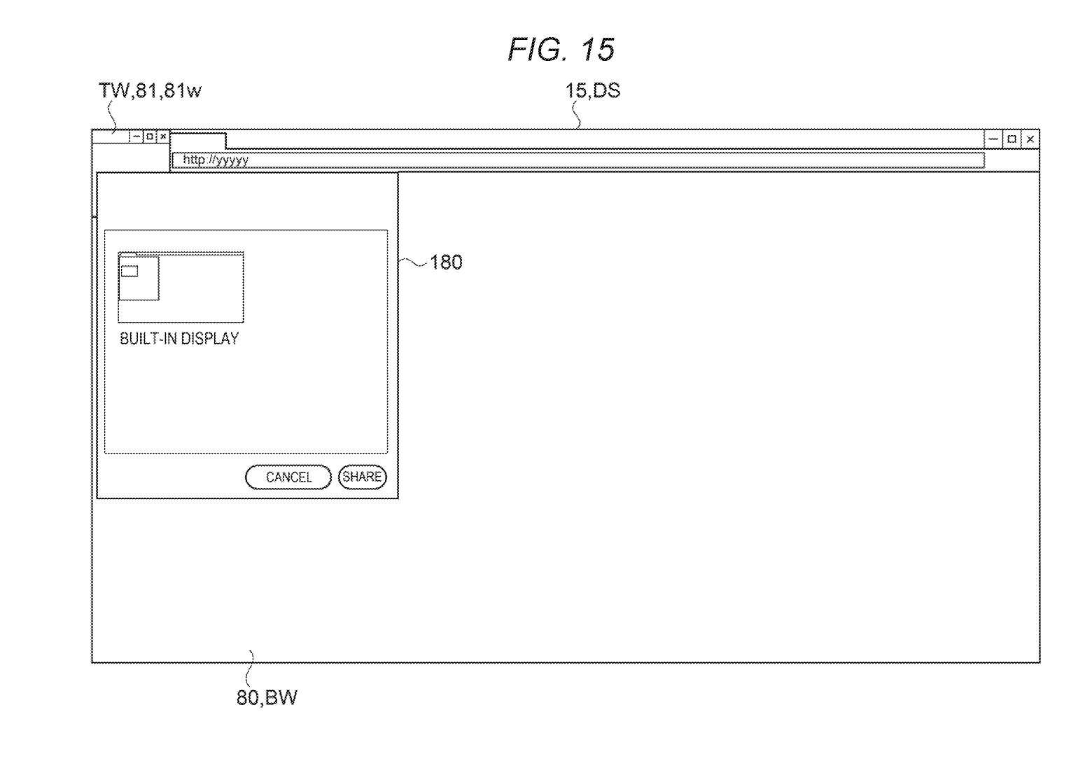

FIG. 15 illustrates an example of the display screen DS. The display screen DS is displayed on the display 15. The display screen DS shown in FIG. 15 represents the display screen DS when the web browser 80 displays the selection screen 180. The display screen DS illustrated in FIG. 15 displays the selection screen 180 and the browser window BW. The selection screen 180 illustrated in FIG. 15 is the same as the selection screen 180 illustrated in FIG. 9. The selection screen 180 is displayed on the web browser 80.

When the selection screen 180 is displayed on the display screen DS, the projection setting page window 81w displayed as the tab window TW is preferably displayed in a reduced size. When the selection screen 180 is displayed on the display screen DS, the web browser 80 displays the projection setting page window 81w in a reduced size. By displaying the projection setting page window 81w in a reduced size, the visibility of the selection screen 180 and the browser window BW is improved.

As illustrated in FIG. 11, after displaying the selection screen 180, the web browser 80 receives the selection instruction operation in step S229. When the user performs a predetermined operation on the share icon 183 in the selection screen 180, the web browser 80 receives the selection instruction operation. When the web browser 80 receives the selection instruction operation, the web browser 80 hides the selection screen 180.

When receiving the selection instruction operation, the web browser 80 acquires the shared data in step S230. The web browser 80 acquires generated data output from the output unit 20 as the shared data due to a function of the capture app 84 operating in the data acquisition page 83. The shared data includes the video data output from the display data output unit 21. The shared data may include the audio data output from the audio output unit 23.

When acquiring the shared data, the web browser 80 displays the data acquisition page window 83w displayed as the tab window TW in the second display size by the acquisition page display processing. By displaying the data acquisition page window 83w in the second display size, the web browser 80 can reduce an occupancy of the data acquisition page window 83w in the display screen DS. The user can visually recognize other portions without being hindered by the data acquisition page window 83w.

When the web browser 80 acquires the shared data, the web browser 80 transmits the shared data to the projector 100 in step S231. The web browser 80 executes shared data transmission processing of transmitting the shared data based on the mirroring start instruction operation to transmit the shared data to the projector 100. The web browser 80 transmits the shared data to the projector 100 via the stream distribution path SP.

When the web browser 80 transmits the shared data to the projector 100, the projector 100 receives the shared data in step S242. The projector communicator 150 of the projector 100 receives the shared data transmitted via the stream distribution path SP. The projector controller 130 acquires the shared data via the projector communicator 150.

When receiving the shared data, the projector 100 executes mirroring in step S243. The projector 100 acquires the video data contained in the shared data. The projection controller 131 of the projector controller 130 transmits the video data to the projection unit 110. The projection controller 131 causes the projection unit 110 to project the video data. The projection unit 110 projects the projection image PG based on the video data onto the projection surface SC. When audio data is contained in the shared data, the projector 100 acquires the audio data contained in the shared data. The projection controller 131 transmits the audio data to the projector built-in speaker 120. The projector built-in speaker 120 outputs an audio based on the audio data. Based on the shared data including the video data and the audio data, the projector 100 displays the display screen DS displayed on the display 15 of the control apparatus 10, and outputs the audio based on the audio data. Based on the shared data including the video data, the projector 100 executes mirroring of projecting the display screen DS.

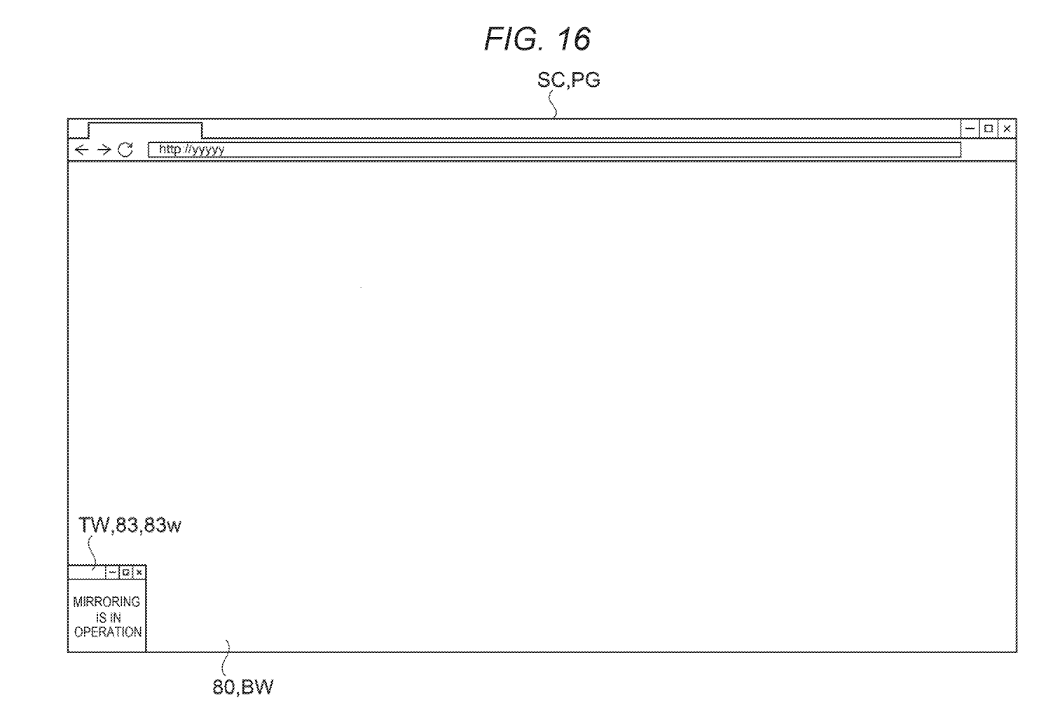

FIG. 16 shows the projection image PG projected on the projection surface SC. FIG. 16 shows the projection image PG projected on the projection surface SC when the projector 100 executes mirroring. The projection image PG is the same image as that of the display screen DS displayed on the display 15. The display screen DS having the same image as the projection image PG is displayed on the display 15.

The projection image PG includes the browser window BW and the tab window TW. The tab window TW is the data acquisition page window 83w including the data acquisition page 83. The data acquisition page window 83w displayed as the tab window TW is displayed in the second display size smaller than the first display size. Since the data acquisition page window 83w is displayed in the second display size, it becomes easy for the user to visually recognize the browser window BW. The display screen DS having the same image as the projection image PG shown in FIG. 16 is displayed on the display 15. It becomes easy for the user to visually recognize the browser window BW.

In the control flow of the control apparatus 10, when the web browser 80 is activated before executing the projection setting page display processing, the projection setting page display processing is to display the projection setting page window 81w in the first display size as the tab window TW of the web browser 80 based on the mirroring instruction operation.

By displaying the projection setting page window 81w as the tab window TW, the display of the web page displayed in the browser window BW before executing the projection setting page display processing is maintained.

The control flow of the control apparatus 10 preferably includes the setting window tab hiding processing of closing the tab window TW based on the mirroring start instruction operation.

By closing the projection setting page window 81w, multiple operations and erroneous operations on the projection setting page window 81w by the user are prevented.

A summary of the present disclosure will be appended below.

### Appendix 1

A method of processing information in an information processing apparatus includes linking to a projection apparatus through a network for data transfer, receiving a display operation of displaying a setting page for setting the projection apparatus on a web browser, executing display processing of displaying a setting window including the setting page in a first size on a display screen based on the display operation, receiving a projection instruction operation of instructing the projection apparatus to project the display screen in the setting page, and executing, based on the projection instruction operation, window display processing of displaying, in a second size smaller than the first size, an acquisition window for acquiring display data for instructing the projection apparatus to project the display screen, and data transmission processing of transmitting the display data to the projection apparatus via the acquisition window.

By the information processing apparatus displaying the acquisition window in the second size, it becomes easy for the user to visually recognize other images than the acquisition window.

### Appendix 2

The method of processing information in the information processing apparatus according to Appendix 1 further includes executing activation processing of activating the web browser based on the display operation when the web browser is not activated before the display operation is received, wherein the display processing is displaying the setting window including the setting page in the first size on the web browser activated.

The information processing apparatus can activate the web browser to display the setting page on the web browser based on the display operation.

### Appendix 3

The method of processing information in the information processing apparatus according to Appendix 1 or 2 further includes executing window hiding processing of closing the setting window based on the projection instruction operation.

By hiding the setting window, multiple operations and erroneous operations on the setting window by the user are prevented.

### Appendix 4

In the method of processing information in the information processing apparatus according to Appendix 1, when the web browser is activated before executing the display processing, the display processing is displaying the setting window in the first size as a tab window of the web browser based on the display operation.

By displaying the setting window as the tab window, the display of the web page displayed on the web browser before executing the display processing is maintained.

### Appendix 5

The method of processing information in the information processing apparatus according to Appendix 4 further includes executing tab window hiding processing of closing the tab window based on the projection instruction operation.

By closing the setting window, multiple operations and erroneous operations on the setting window by the user are prevented.

### Appendix 6

A display system includes a projection apparatus, and an information processing apparatus in which a web browser operates, wherein the information processing apparatus is configured to execute linking to a projection apparatus through a network for data transfer, receiving a display operation of displaying a setting page for setting the projection apparatus on the web browser, performing display processing of displaying a setting window including the setting page in a first size on a display screen based on the display operation, receiving a projection instruction operation of instructing the projection apparatus to project the display screen in the setting page, performing, based on the projection instruction operation, window display processing of displaying, in a second size smaller than the first size, an acquisition window for acquiring display data for instructing the projection apparatus to project the display screen, and data transmission processing of transmitting the display data to the projection apparatus via the acquisition window, and transmitting the display data to the projection apparatus, and the projection apparatus is configured to execute receiving the display data from the information processing apparatus, and projecting the display screen based on the display data.

By the information processing apparatus displaying the acquisition window in the second size, it becomes easy for the user to visually recognize other images than the acquisition window on the display or the projection surface.

What is claimed is:

1. A method of processing information in an information processing apparatus comprising:
linking to a projection apparatus through a network for data transfer;
receiving a display operation of displaying a setting page for setting the projection apparatus on a web browser;
executing display processing of displaying a setting window including the setting page in a first size on a display screen based on the display operation;
receiving a projection instruction operation of instructing the projection apparatus to project the display screen in the setting page; and
executing, based on the projection instruction operation, window display processing of displaying, in a second size smaller than the first size, an acquisition window for acquiring display data for instructing the projection apparatus to project the display screen, and data transmission processing of transmitting the display data to the projection apparatus via the acquisition window.

2. The method of processing information in the information processing apparatus according to claim 1, further comprising
executing activation processing of activating the web browser based on the display operation when the web browser is not activated before the display operation is received, wherein
the display processing is displaying the setting window including the setting page in the first size on the web browser activated.

3. The method of processing information in the information processing apparatus according to claim 2, further comprising
executing window hiding processing of closing the setting window based on the projection instruction operation.

4. The method of processing information in the information processing apparatus according to claim 1, wherein
when the web browser is activated before executing the display processing, the display processing is displaying the setting window in the first size as a tab window of the web browser based on the display operation.

5. The method of processing information in the information processing apparatus according to claim 4, further comprising
executing tab window hiding processing of closing the tab window based on the projection instruction operation.

6. A display system comprising:
a projection apparatus; and
an information processing apparatus in which a web browser operates, wherein
the information processing apparatus is configured to execute:
linking to the projection apparatus through a network for data transfer;
receiving a display operation of displaying a setting page for setting the projection apparatus on the web browser;
performing display processing of displaying a setting window including the setting page in a first size on a display screen based on the display operation;
receiving a projection instruction operation of instructing the projection apparatus to project the display screen in the setting page;
performing, based on the projection instruction operation, window display processing of displaying, in a second size smaller than the first size, an acquisition window for acquiring display data for instructing the projection apparatus to project the display screen, and data transmission processing of transmitting the display data to the projection apparatus via the acquisition window; and
transmitting the display data to the projection apparatus, and
the projection apparatus is configured to execute:
receiving the display data from the information processing apparatus; and
projecting the display screen based on the display data.
